(19) United States
(12) Patent Application Publication
(10) Pub. No.: US 2021/0263537 A1
(43) Pub. Date: Aug. 26, 2021

(54) UAV SYSTEMS, INCLUDING AUTONOMOUS UAV OPERATIONAL CONTAINMENT SYSTEMS, AND ASSOCIATED SYSTEMS, DEVICES, AND METHODS

(71) Applicant: Skytask, Inc., Niwot, CO (US)

(72) Inventors: David Christopher Belt, Fort Collins, CO (US); Paul Albert Ragland, Niwot, CO (US)

(21) Appl. No.: 17/179,970

(22) Filed: Feb. 19, 2021

Related U.S. Application Data
(60) Provisional application No. 62/981,068, filed on Feb. 25, 2020.

(51) Int. Cl. G05D 1/10; H04B 7/185; G08G 5/02; G08G 5/00; B64C 39/02; B64F 1/36; G05D 1/00; G06T 7/00

(52) U.S. Cl. CPC G05D 1/101; H04B 7/18506; G08G 5/025; G08G 5/0013; G08G 5/0069; B64C 2201/145; B64C 39/024; B64F 1/36; G05D 1/0088; G06T 7/001; B64C 2201/027; G08G 5/0034

(57) ABSTRACT

Unmanned aerial vehicle (UAV) systems, including autonomous UAV operational containment systems, and associated systems, devices, and methods are disclosed herein. In one embodiment, a UAV operational containment system includes a cloud-based flight manager, a control tower, and navigation beacons. The control tower is configured for direct communication with the flight manager. Each navigation beacon is configured for communication with the control tower and for communication with the flight manager via the control tower. The system can further include a UAV having a first localization system and a second localization system. Each localization system is configured to determine a position of the UAV independent of the other localization system. In some embodiments, the system is configured to contain the UAV within an operational envelope defined for the site of operation and/or to execute a pre-defined emergency flight plan in the event of an in-flight emergency.

### CROSS-REFERENCE TO RELATED APPLICATIONS

This application claims the benefit of U.S. Provisional Patent Application No. 62/981,068, filed Feb. 25, 2020, which is incorporated by reference herein in its entirety.

This application is related to U.S. patent application Ser. No. 17/179,871, which (i) was filed concurrently herewith on Feb. 19, 2021, (ii) is titled “UAVS, INCLUDING MULTI-PROCESSOR UAVS WITH SECURED PARAMETERS, AND ASSOCIATED SYSTEMS, DEVICES, AND METHODS,” and (iii) is incorporated by reference herein in its entirety.

### TECHNICAL FIELD

The present disclosure generally relates to unmanned aerial systems. In particular, the present technology relates to unmanned aerial vehicle (UAV) systems, including autonomous UAV operational containment systems, and associated systems, devices, and methods.

### BACKGROUND

A UAV (otherwise known as a drone or an uncrewed aerial vehicle) is an aircraft that lacks a human pilot onboard. UAVs are often used in logistics operations (e.g. to deliver cargo); in civil or commercial settings (e.g., to capture aerial photographs, collect data, etc.); and/or in combat or reconnaissance operations. UAVs are also used in other settings, such as in recreational activities.

Commonly, UAVs are part of systems that also include ground-based controllers in communication with a corresponding UAV. In these systems, the controllers are often operated by a human such that the UAV is flown under full or partial control by the human. Additionally, or alternatively, the ground-based controller may be fully or partially operated without a human, or a UAV might include a controller (e.g., an autopilot) onboard, thereby enabling the UAV to fly with various degrees of autonomy.

UAVs can threaten airspace security in numerous ways, including intentional or unintentional (a) collisions or interference with other aircraft or objects and/or (b) flights over sensitive (e.g., confidential) areas or within restricted airspace. Therefore, many UAVs are subject to governmental regulations. In the United States, UAVs are subject to regulations defined by the Federal Aviation Administration (FAA). For example, the FAA requires registration of UAVs that weigh above 250 grams and defines airspace within which UAVs are restricted from flying (e.g., typically airspace at altitudes of approximately 122 meters or higher).

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments depicted, but are for explanation and understanding only.

FIG. 1A is a partially schematic representation (a) of an autonomous UAV operational containment system configured in accordance with various embodiments of the present technology and (b) of an environment in which the autonomous UAV operational containment system operates.

FIG. 1B is a partially schematic diagram of an example site of operation at which an autonomous UAV operational containment system of the present technology can be employed.

FIG. 2 is a block diagram of a flight manager in an autonomous UAV operational containment system, configured in accordance with various embodiments of the present technology.

FIG. 3 is a block diagram of a UAV in an autonomous UAV operational containment system, configured in accordance with various embodiments of the present technology.

FIG. 4 is a block diagram of a control tower in an autonomous UAV operational containment system, configured in accordance with various embodiments of the present technology.

FIG. 5 is a block diagram of a navigation beacon in an autonomous UAV operational containment system, configured in accordance with various embodiments of the present technology.

FIG. 6 is a partially schematic representation of a UAV inspection system in an autonomous UAV operational containment system, configured in accordance with various embodiments of the present technology.

FIG. 7 is a flow diagram illustrating a method of defining an operational envelope and safe landing zones for a UAV and of deploying an autonomous UAV operational containment system at a site of operation, in accordance with various embodiments of the present technology.

FIG. 8 is partially schematic diagram of a user interface illustrating an example site of operation, an example operational envelope, example safe landing zones, and an example deployment layout for the site of operation, in accordance with various embodiments of the present technology.

FIG. 9 is a flow diagram illustrating a method of operating an autonomous UAV operational containment system in accordance with various embodiments of the present technology.

FIG. 9A is a flow diagram illustrating a method of executing a flight plan in accordance with various embodiments of the present technology.

FIG. 9B is a flow diagram illustrating another method of executing a flight plan in accordance with various embodiments of the present technology.

### DETAILED DESCRIPTION

### A. Overview

As discussed above, UAVs can threaten airspace security in numerous ways, including intentional or unintentional (a) collisions or interference with other aircraft or objects or (b) flights over sensitive areas or within restricted airspace (e.g., for surveillance purposes). UAV geo-fencing technology included in some UAV technologies, is designed to combat this threat by preventing the UAV from passing into or out of a pre-defined geographic space. The primary use for this technology is the enforcement of regulatory (e.g., FAA) airspace rules and preventing the UAV from entering space for which it is not authorized.

Most geo-fence deployments are software implementations on the UAV itself. Thus, the UAV is configured to stop the aircraft when it determines it has reached a geo-fence boundary and to hover until provided another direction from the pilot-in-command. But these software geo-fencing implementations are vulnerable to hack and only work in the event the UAV's localization system hasn't failed or malfunctioned. Thus, the UAV cannot be trusted as a standalone entity. Indeed, most UAV manufacturers state that geofencing technology is for pilot-in-command notification purposes only, thereby implying that the UAV is not a trusted device.

To address these concerns, the inventors have developed a fully autonomous UAV operational containment system that (a) can be entrusted to enforce an operational envelope defined for a UAV and (b) can operate in the field (e.g., in beyond visual line of site (BVLOS) settings) without being hacked and without human control or intervention. In some embodiments, the system includes a UAV, one or more control towers, a plurality of navigation beacons, and a cloud-based flight manager. The control tower(s) (a) communicate directly with the flight manager and (b) form a mesh network with the navigation beacons, thereby placing all components of the system in communication with one another. In some embodiments, the system further includes a UAV inspection system that (a) serves as a docking station for the UAV when not in flight and (b) provides UAV health integrity checks to identify any damage to the UAV pre-flight.

In these and other embodiments, the system defines an operational envelope in which the UAV is permitted to fly and securely binds the UAV to this envelope. Redundant localization systems and techniques for continuously monitoring the UAV and other environmental conditions at a site of operation increase the likelihood that the UAV will remain safe and within the operational envelope during flight operations. For example, the UAV of the system can include multiple localization systems. The multiple localization systems can provide back-up in the event that one of the localization systems fails, malfunctions, or is otherwise compromised (e.g., hacked). Additionally, or alternatively, the UAV can include multiple processors. One of the processors can serve as the main processor for the UAV and execute most of the decision making of the UAV during flight. Another of the processors can (a) oversee operation of the main processor by independently analyzing data collected by and/or provided to the UAV, and (b) intercede when it detects that the UAV has or is about to violate the operational envelope. The multiple processors therefore increase the likelihood for safely operating the UAV within the operational envelope even in the event the main processor fails, malfunctions, or is otherwise compromised (e.g., hacked). Furthermore, the system can define an emergency flight plan tied to a UAV's flight path. The emergency flight plans can specify a safe landing zone for every point or segment of the flight path.

In the event the system identifies an emergency while the UAV is in flight, the UAV can execute the emergency flight plan to land at the safe landing zone specified in the emergency flight plan.

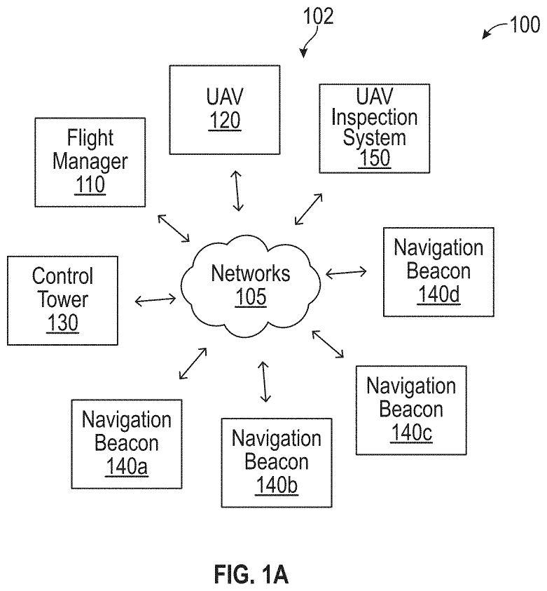

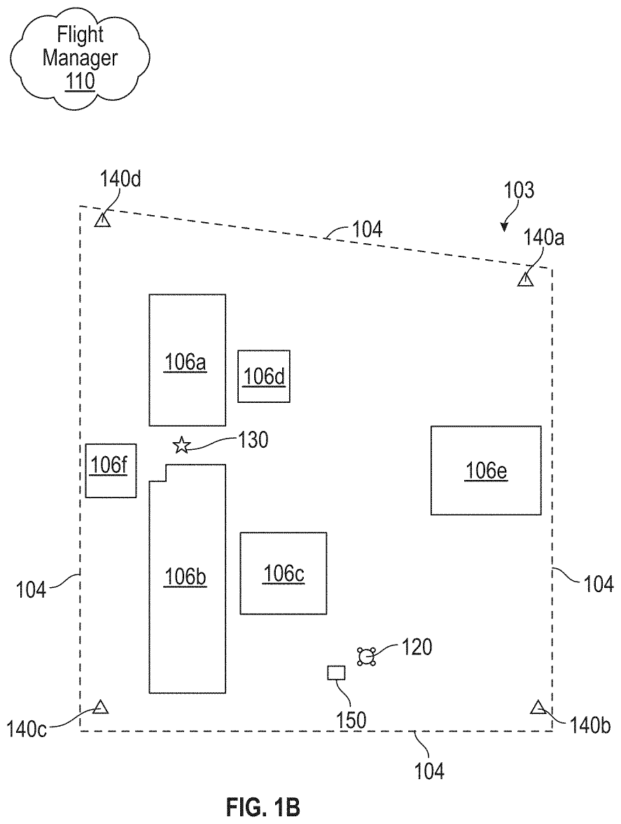

Specific details of several embodiments of the present technology are described herein with reference to FIGS. 1-9B. Although many of the embodiments of autonomous UAV operational containment systems discussed herein are described in relation to commercial settings (e.g., to capture aerial photographs, collect data, and/or perform other commercial-related tasks), other applications and other embodiments in addition to those described herein are within the scope of the present technology. For example, unless otherwise specified or made clear from context, the systems, devices, and methods of the present technology can be used in nearly any context in which a UAV is employed. As specific examples, the systems, devices, and methods of the present technology can be employed in civil settings (e.g., to inspect roads or bridges, to track or help fight wildfires, and/or to perform other public service tasks) or in recreational activities. The systems, devices, and methods of the present technology may also be applicable in combat or surveillance operations.

It should be noted that other embodiments in addition to those disclosed herein are within the scope of the present technology. Further, embodiments of the present technology can have different configurations, components, and/or procedures than those shown or described herein. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

### B. Selected Embodiments of UAV Systems, Including Autonomous UAV Operational Containment Systems, and Associated Systems, Devices, and Methods

1. Autonomous UAV Operational Containment Systems

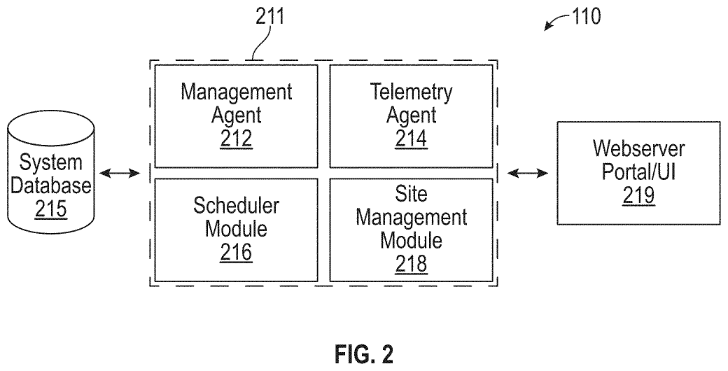

FIG. 1A is a partially schematic representation (a) of an autonomous UAV operation containment system 100 (“the system 100”) and (b) of an environment 102 in which the system 100 operates. FIG. 1B is a partially schematic diagram of a site of operation 103 at which the system 100 of FIG. 1A can be employed. In the embodiment illustrated in FIG. 1A, the system 100 includes a flight manager 110; a UAV 120; a control tower 130; navigation beacons 140 (identified individually as navigation beacons 140a-140d); and a UAV inspection system 150. The flight manager 110, the UAV 120, the control tower 130, the navigation beacons 140, and the UAV inspection system 150 are individually discussed in greater detail below with reference to FIGS. 2-6, respectively. In some embodiments, the system 100 can include additional or fewer components than are shown in FIG. 1A. For example, the system 100 can include more than one UAV 120, more than one control tower 130, a greater or lesser number (e.g., zero, one, two, three, or more than four) navigation beacons 140, and/or a greater or lesser number (e.g., zero or more than one) UAV inspection systems 150.

Referring to FIG. 1B, the site of operation 103 (which is viewed from above) includes property boundary lines 104 and various obstacles 106 (e.g., buildings 106a-106d, parking lots 106e, and other infrastructure 106f). The UAV 120, the control tower 130, the navigation beacons 140, and the UAV inspection system 150 are physically deployed at the site of operation 103 at various positions within the property boundary lines 104. In contrast, the flight manager 110 is a collection of cloud-based hardware and software components operating outside the site of operation 103. The cloud-based flight manager eliminates costs and complexities of setting up and maintaining the flight manager at the site of operation, including heavy investments in hardware needed to operate the flight manager, transferring the hardware to each site of operation (which are often rural), and/or setting up and maintaining the flight manager on site. Furthermore, an onsite flight manager is typically limited in processing power to the hardware onsite. In contrast, a cloud-based flight manager can be easily scaled to provide any level of processing power required for a sight of operation. In addition, having a cloud-based flight manager can be advantageous to provide access to the system from anywhere there is an Internet connection. Moreover, a cloud-based flight manager permits clients operating multiple sites of operation to use the same interface to control the system at any one of the sites of operation merely by logging into their account and specifying the site of operation in the flight manager.

In the illustrated embodiment, the control tower 130 is centrally located within the site of operation 103 to provide connectivity between (a) the UAV 120, the navigation beacons 140a-140d, and/or the UAV inspection system 150 and (b) the flight manager 110 over a wide area network (WAN), such as a broadband network and/or the Internet. Furthermore, the navigation beacons 140a-140d are deployed at corners and/or along the perimeter of the site of operation 103 to provide, in combination with the control tower 130, a continuous local area network (LAN) (e.g., a mesh network) over the site of operation 103. As described in greater detail below, however, the positions of the control tower 130 and/or of the navigation beacons 140a-140d can vary from the positions illustrated in FIG. 1B and/or can be based at least in part on characteristics (e.g., geometry and/or topography) of a site of operation.

Referring again to FIG. 1A, the components of the system 100 are connected to and communicate through one or more networks 105 of the environment 102. Networks 105 may be any type of public or private, wired or wireless, network connection suitable for transporting data between nodes. In some embodiments, the Internet is one of the networks 105 used to provide connectivity, but other networks (e.g., LANs, metropolitan area networks (MANs), or other WANs) may additionally or alternatively be used. For example, the components of the system 100 can be connected through dedicated landlines or through a terrestrial or satellite wireless network.

The networks 105 may include various network topologies, such as mesh networking or star/tree networking. The networks 105 can employ various communication protocols. For example, the networks 105 can employ various wireless communication protocols, including WiFi, Zigbee, Z-Wave, Bluetooth, Bluetooth LE, or another wireless network protocol (e.g., cellular network protocols, such as 3G, 4G, or 5G). Additionally, or alternatively, the networks can employ various Internet protocols (e.g., Transmission Control Protocol/Internet Protocol (TCP/IP)) and/or various messaging protocols (e.g., MQ Telemetry Transport (MQTT) or hypertext transfer protocol (HTTP)). In these and other embodiments, the networks 105 can employ the Micro Air Vehicle Link (MAVlink) protocol for certain communications involving the UAV 120.

As a specific example, the control tower 130 communicates with the flight manager 110 over the networks 105 using a secure communication channel (e.g., a virtual private network (VPN)) established over a WAN, such as a broadband network and the Internet. Additionally, the networks 105 include a LAN (e.g., a wireless mesh network) formed by the control tower 130 and the navigation beacons 140a-140d. The LAN is used to place the UAV 120, the navigation beacons 140a-140d, and/or the UAV inspection system 150 in communication with (a) the control tower 130 and/or (b) the flight manager 110 over the WAN (e.g., via the control tower 130 and/or only via the control tower 130). In one embodiment, the control tower 130 communicates with the navigation beacons 140a-140d over the LAN using the Zigbee communication protocol. Furthermore, the UAV 120 can communicate with the control tower 130 and/or with the navigation beacons 140a-140d using a communication protocol in which the round trip time (RTT) of packets of information can be calculated. As discussed in greater detail below, RTTs of information packets can be used to calculate the position of the UAV 120 in space.

In some embodiments, the networks 105 can provide communication redundancy. For example, various components of the system 100 can include both (a) global positioning systems (GPS) that use, for example, global navigation satellite systems (GNSS) and (b) a wireless LAN that facilitates trilateration calculations. This provides the components of the system 100 two methodologies of determining their positions in space, thereby improving accuracy and reliability of the system 100. Various components of the system 100 can additionally, or alternatively, include “n” number of radios or communication devices to create “n” level redundancy for communication and/or localization.

For the sake of clarity and explanation, the LAN formed by the control tower 130 and the navigation beacons 140 is referred to hereinafter as a mesh network. Additionally, the WAN that facilitates communication between the flight manager 110 and the control tower 130 (and/or other components of the system 100) deployed at the site of operation 103 is referred to hereinafter as a broadband network and/or the Internet. A person of ordinary skill in the art, however, will readily recognize that the LAN in other embodiments of the present technology can include one or more other network configurations in addition to or in lieu of mesh network, and/or that the WAN in other embodiments of the present technology can include one or more other network configurations in addition to or in lieu of a broadband network and/or the Internet.

FIG. 2 is a block diagram of the UAV flight manager 110 of the system 100 illustrated in FIGS. 1A and 1B. In some embodiments, the flight manager 110 is a collection of cloud-based hardware and software components that serve as the overall orchestrator of the system 100. For example, the flight manager 110 handles (a) UAV flight planning, operational envelope definition, and device provisioning, as well as (b) system deployment and flight data management.

As shown in FIG. 2, the flight manager 110 includes various agents or modules 211. These include a management agent 212, a telemetry agent 214, a scheduler module 216, and a site management module 218. The management agent 212 communicates with the UAV 120 (FIGS. 1A and 1B) and with the navigation beacons 140a-140d (FIGS. 1A and 1B) of the system 100 via direct communication with the control tower 130 (FIGS. 1A and 1B). For example, the management agent 212 receives weather, air traffic data (e.g., automatic dependent surveillance-broadcast (ADS-B) data, radar data, and/or other data (such as acoustic data and/or light detection and ranging (LIDAR) data) indicative of aircraft or objects in flight), positional information, and/or other data from the control tower 130 and/or the navigation beacons 140. In some embodiments, the management agent 212 employs one or more servers that use the MQTT messaging protocol to manage the UAV 120, the control tower 130, and the navigation beacons 140a-140d, for example, as an Internet of Things (IoT) device network.

The telemetry agent 214 communicates with the UAV 120 over the mesh network formed via the control tower 130 and the navigation beacons 140a-140d. In some embodiments, the telemetry agent 214 uses the MavLink communication protocol to provide real-time communication and control of the UAV 120 during active flight operations. The scheduler module 216 controls all aspects of scheduled activities, such as scheduled UAV flight plans and supporting functions. The site management module 218 manages all aspects of an individual site deployment, such as deployment of system components, air traffic management, user management, and site conditions as they relate to UAV flight.

In some embodiments, the flight manager 110 can include one or more other agents or modules. For example, the flight manager 110 can include a secure parameters module (not shown) and/or a secure keying facility (not shown). The secure parameters module and/or the secure keying facility can manage storing and/or securing (e.g., digitally signing and/or encrypting) various system parameters, such as operational envelope parameters that can be provided to the UAV 120. The secure parameters module and the secure keying facility and their functions are discussed in greater detail in U.S. patent application Ser. No. 17/179,871.”

In some embodiments, various agents and modules of the flight manager 110 are distributed over multiple physical devices, and/or the functionality implemented by the agents and modules may be provided by calls to remote servers. Moreover, multiple servers may be used to implement various functions of the flight manager 110 described herein. In these and other embodiment, the agents and modules of the flight manager 110 can be co-located (e.g., on a single server or on a group of servers in close proximity to one another). The software to support the functionality of the flight manager 110 may be stored on one or more computer-readable media, such as an optical drive, flash memory, hard drive, or other storage device, or combination of such storage devices.

In the illustrated embodiment, the flight manager 110 further includes a system database 215 and a webserver portal and/or user interface 219 (“the webserver portal 219”). The database 215 stores various data of the system 100, including data regarding deployment sites, users, companies, and the like. For example, as described in greater detail below, the flight manager 110 receives positional information, environmental condition data, and/or video/image data from the control tower 130, the navigation beacons 140, and/or the UAV 120 of the system 100. All or a subset of this information can be stored, for example, in the system database 215. Additionally, or alternatively, the flight manager 110 can use all or a subset of this information as inputs for identifying site conditions (e.g., emergencies) and/or for making various flight-related decisions (e.g., appropriate responses to identified emergencies) for the UAV 120. In some embodiments, the database 215 is a MySQL database. The database 215 can be local or remote, and/or can be distributed in one or more physical devices.

The webserver portal 219 of the flight manager 110 provides a user interface (e.g., via an application interface running on a computing device, such as a user's tablet, laptop, and/or mobile phone) that extends a user control over specific aspects of the system 100. For example, the webserver portal 219 can present a user a site of operation as a map interface that permits the user (a) to deploy various components of the system 100, (b) check the statuses of various components of the system 100, (c) communicate directly with individual components of the system 100, and/or (d) to define UAV flight operational envelope parameters, such as property boundaries, no fly zones, altitude restricted areas, and/or safe landing zones. A user may also, via the webserver portal 219, (i) define, schedule, and/or trigger UAV flights, and/or (iii) manually control a UAV in active flight.

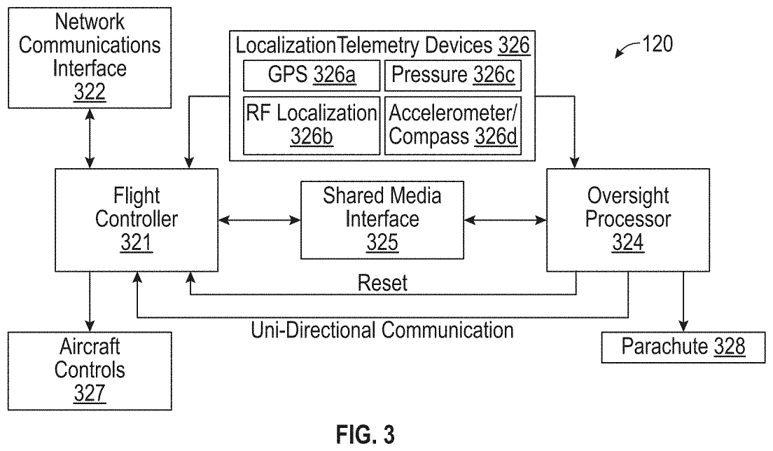

FIG. 3 is a block diagram of the UAV 120 of the system 100 (FIGS. 1A and 1B). As shown, the UAV 120 has a multi-processor architecture (in this case, a dual-processor architecture) comprising an onboard flight controller 321 and an onboard oversight processor 324. The UAV 120 further includes a shared media interface 325, localization telemetry devices 326, aircraft control mechanisms 327, a (e.g., WAN and/or LAN) network communications interface 322, and a parachute 328. In some embodiments, the shared media interface 325 is a memory interface (e.g., a non-volatile memory interface) configured to receive system parameters from memory media. The memory media can be non-volatile memory, such as onboard flash memory, a removable secure digital (SD) card or smart card, and/or another memory medium configured to persistently store the system parameters, such as operational envelope parameters that define an operational envelope for the UAV 120 and/or safe landing zone parameters that identify the locations of safe landing zones for the UAV. Examples of operational envelope parameters that can be received from memory via the shared media interface 325 include locations of (a) site, property, and/or perimeter boundaries, (b) no-fly zones, and/or (c) altitude restricted areas.

The operational envelope parameters and/or the safe landing zone parameters received via the shared media interface 325 are provided to both the flight controller 321 and the oversight processor 324. In some embodiments, the parameters are encrypted, and the flight controller 321 and the oversight processor 324 use unique credentials to decrypt the parameters. This enables secure provisioning of the parameters to a specific UAV 120.

The localization telemetry devices 326 can include a variety of sensors, such as a GPS 326a, a radiofrequency (RF) localization system 326b, a pressure sensor 326c, and/or an accelerometer and/or compass 326d. The GPS 326a and the RF localization system 326b are used to determine the position of the UAV 120 in two-dimensional and/or three-dimensional space. For example, the RF localization system 326b can include an RF radio (e.g., a 900 MHz radio) configured to communicate with one or more control towers 130 (e.g., the control tower 130 of FIGS. 1A and 1B) and/or multiple (e.g., two or more) navigation beacons 140 (e.g., two or more of the navigation beacons 140a-140d of FIGS. 1A and 1B). As described in greater detail below, the RF localization system 326b can use a communications protocol (e.g., Zigbee, Bluetooth, and/or another suitable protocol) that enables the RF localization system 326b to capture the RTT of packets of information sent to and received from the navigation beacons 140 and/or the control tower(s) 130. Because the position of each control tower 130 and navigation beacon 140 of the system 100 is known, the RTTs of packets sent to three or more components of the system 100 at any given time can be used to determine (via trilateration) the position of the UAV 120 in two-dimensional and/or three-dimensional space at that given time. The GPS 326a and the RF localization system 326b can be independently used to determine the UAV's 120 position, so the GPS 326a and the RF localization system 326b provide the UAV 120 localization redundancy.

The pressure sensor 326c can independently be used to determine the UAV's 120 altitude. For example, the UAV 120 can calibrate the pressure sensor 326c using, for example, a barometric pressure reading captured at ground level at or near the site of operation 103 (e.g., a pressure reading captured by a pressure sensor on the control tower 130 and/or on a navigation beacon 140, a pressure reading broadcasted by a nearby airfield in Meteorological Aerodrome Reports (METARs), and/or a pressure reading captured by the pressure sensor 326c of the UAV 120 while the UAV 120 is positioned on or near the ground, such as when the UAV 120 is grounded at the UAV inspection system 150). An altitude of the UAV 120 can then be calculated from barometric pressure readings taken by the pressure sensor 326c, for example, while the UAV 120 is in flight. Thus, the pressure sensor 326c can be used as a redundancy to the UAV's altitude determined using the GPS 326a and/or the RF localization system 326b.

As shown in FIG. 3, data captured by the GPS 326a, the RF localization system 326b, the pressure sensor 326c, and/or the accelerometer and/or compass 326d is supplied to both the flight controller 321 and the oversight processor 324. If additional redundancy is desired, separate localization radios can be provided on the UAV 120 for each of the flight controller 321 and the oversight processor 324. For example, the UAV 120 in other embodiments can include two GPSs 326a (one for the flight controller 321 and one for the oversight processor 324) and/or two RF localization systems 326b (one for the flight controller 321 and one for the oversight processors 324). In some embodiments, additional localization radios are provided on the UAV to safely land the UAV in the event one or more of the localization radios fails, malfunctions, or is otherwise compromised (e.g., is hacked).

The flight controller 321 can function as the main controller or processor of the UAV 120 and primarily control actual flight and operation of the UAV 120, limited to the operational envelope defined by system parameters received over the shared media interface 325. In particular, the flight controller 321 can receive a flight plan from the flight manager 110 over the network communications interface 322. The flight plan can define a flight path within the operational envelope. Using (a) localization information received from the localization telemetry devices 326 and (b) the aircraft control mechanisms 327, the flight controller 321 can (e.g., autonomously or at the direction of the flight manager 110 and/or of a user) navigate the UAV 120 along the flight path, thereby executing the flight plan. During flight, the flight controller 321 responds to any commands it receives from the flight manager 110 over the network communications interface 322. These commands can include, for example, emergency instructions for maneuvering the UAV 120 in response to changes in flight conditions (e.g., in response to a possible collision event between the UAV 120 and another object, in response to a change in weather conditions, and/or in response to another change posing a risk to the UAV) and/or instructions for navigating the UAV 120 in accordance with manual control of the UAV 120 provided to a user via the webserver portal 219 (FIG. 2) of the flight manager 110. In some embodiments, the flight controller 321 references the operational envelope as a geofence for the UAV 120 and prevents operation of the UAV 120 outside of the operational envelope. For example, when the UAV 120 is manually controlled by a user and the UAV 120 encounters a boundary of the operational envelope, the flight controller 321 can stop the UAV 120 and cause the UAV 120 to hover in place until the flight controller 321 receives a navigational command from the user and/or the flight manager 110 that will not cause the UAV 120 to breach the operational envelope.

The oversight processor 324 separately oversees the behavior of the flight controller 321, enhancing safe operation of the UAV 120 within the operational envelope. In one example, the oversight processor 324 continually monitors the UAV's 120 position in space and compares the position to the operational envelope parameters. When the flight controller 321 safely operates the UAV 120 within the operational envelope defined by the parameters, the oversight processor 324 passively monitors the information it receives from the localization telemetry devices 326 and takes no action. On the other hand, in the event that the oversight processor 324 determines that the flight controller 321 is operating at, near, or beyond the operational envelope defined by the parameters, the oversight processor 324 can communicate with the flight controller 321 over a uni-directional communications line to trigger an alert or alarm, to reduce operational velocity of the UAV 120, force execution of alternate instructions (e.g., to hover in place, to immediately return the UAV 120 to within the operational envelope and/or to the flight path, to land the UAV 120 within a safe landing zone, to return the UAV 120 to its original take off location, and/or to perform another action to attempt to bring the UAV back into a safe operating state), to execute a gradual shutdown procedure, and/or to temporarily or permanently disable the UAV 120. Additionally, or alternatively, the oversight processor 324 can employ a flight termination system in the event the flight controller 321 is operating at, near, or beyond the UAV's operational envelope. For example, the oversight processor can assert a reset signal over a uni-directional reset communications line to temporarily or permanently cease functionality of the flight controller 321, and/or to the oversight processor can deploy the parachute 328 of the UAV 120 (allowing the UAV 120 to safely drop to the ground).

In some embodiments, the oversight processor 324 does not control actual flight and operations of the UAV 120, leaving this control to the flight controller 321. In these embodiments, the oversight processor 324 merely oversees operation of the flight controller 321 and intercedes when it detects a violation of system parameters (e.g., of operational envelope parameters associated with the UAV 120), which can indicate that the flight controller 321 has failed, is malfunctioning, and/or has become compromised (e.g., hacked). Additionally, or alternatively, the oversight processor 324 is largely (e.g., completely or nearly completely) offline, meaning that the oversight processor does not receive instructions from the flight manager 110 or other components of the system 100. This can decrease the likelihood that the oversight processor 324 becomes compromised (e.g., hacked).

In some embodiments, the flight controller 321 and/or the oversight processor 324 continuously monitor the UAV's position and altitude in space by comparing (a) the UAV's position determined using the GPS 326a of the localization telemetry devices 326 to (b) the position determined using the RF localization system 326b of the localization telemetry devices 326. Additionally, or alternatively, the flight controller 321 and/or the oversight processor 324 can perform a similar comparison of the altitude of the UAV 120 determined using the GPS 326a and/or the RF localization system 326b to an altitude of the UAV 120 determined using the pressure sensor 326c of the localization telemetry devices 326. In the event the determined positions and/or the determined altitudes vary by greater than a threshold amount, the flight controller 321 and/or the oversight processor 324 can instruct the UAV 120 to hover in place, land within a safe landing zone, or take another precautionary action until the determined positions and/or the determined altitudes stabilize and come back into alignment. Failure to stabilize or come back into alignment can indicate a hardware malfunction or a potential localization hack. The UAV 120 can take similar action in response to other in-flight emergencies, such as loss of communication with the control tower(s) 130 or the navigation beacons 140, or loss of sensor or air traffic data in the area of the UAV 120. In this manner, the multi-processor architecture of the UAV 120 increases the likelihood that a UAV 120 is brought back to a safe operating state in the event of failure, malfunction, or other compromise (e.g., hack) of the flight controller 321, of one or more localization telemetry devices 326, other components of the UAV 120, and/or other components of the system 100. A more detailed explanation of the architecture of the UAV 120; the secure provisioning of operational envelope and/or safe landing zone parameters to the UAV 120; and of the response of the UAV 120 to failure, malfunction, and/or other compromise of the flight controller 321, of one or more localization telemetry devices 326, and/or other components of the UAV 120 is provided in U.S. patent application Ser. No. 17/179,871.

In some embodiments, the UAV 120 includes a body or housing, one or more propellers, and a camera configured to capture in-flight video or still images. In these and other embodiments, the body or housing of the UAV 120 can store or enclose the parachute 328. In these and still other embodiments, the UAV 120 can include other equipment (e.g., in addition to or in lieu of a camera). The body/housing, number and/or orientation of propellers, and/or other equipment included in the UAV 120 can be tailored to a specific task for which a UAV 120 is employed. For example, a UAV 120 employed for logistics operations (e.g., delivering packages) can include a body/housing, a number of selectively oriented propellers, and/or a gripping mechanism in addition to or in lieu of a camera such that the UAV 120 is suitable to perform the logistics operations.

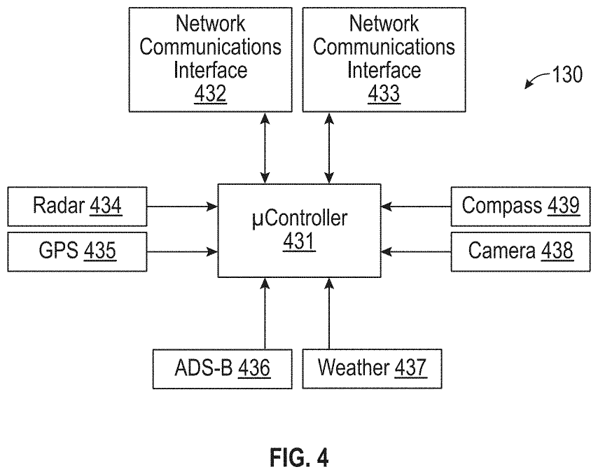

FIG. 4 is a block diagram of the control tower 130 of the system 100 (FIGS. 1A and 1B). As shown, the control tower 130 includes a microcontroller 431 that serves as a bridge between two network communications interfaces 432 and 433. In some embodiments, the network communications interface 432 is a WAN communications interface (e.g., a broadband network radio) configured to facilitate communications between the flight manager 110 (FIGS. 1 and 2) and the control tower 130 over, for example, a secure communications channel, such as a VPN. In these and other embodiments, the network communications interface 433 is a LAN communications interface (e.g., a mesh network radio) configured to facilitate communication between (a) the control tower 130, (b) the navigation beacons 140 (FIGS. 1A and 1B), (c) the UAV 120 (FIGS. 1 and 3), and/or (d) the UAV inspection system 150 (FIGS. 1A and 1B). Thus, the control tower 130 serves as the primary communications gateway between (a) the flight manager 110 and (b) the various components of the system 100 deployed at a site of operation. In this manner, the control tower 130 (i) forms a LAN (e.g., a mesh communications network) with the navigation beacons 140 and (ii) provides WAN (e.g., broadband and/or Internet) connectivity to all components of the system 100 deployed at the site of operation so as to enable communication between the flight manager 110 in the cloud and a UAV 120 deployed at the site of operation.

In some embodiments, the control tower 130 can include various sensors and systems to collect environmental condition data related to the site of operation. For example, in the illustrated embodiment, the control tower 130 includes a radar system 434, a GPS 435, an ADS-B radio 436, weather sensors 437, a camera 438, and a compass 439. The compass 439 can provide the orientation of the control tower 130. The GPS 435 can determine positional information of the control tower 130 using, for example, GNSS. In some embodiments, the control tower 130 can serve as an real-time kinematic (RTK) GNSS base station for the system 100 and can relay correction parameters to the GPS radios included in other components of the system 100 (e.g., in the navigation beacons 140 and/or in the UAV 120), thereby providing centimeter-level (or greater) accuracy in the data reported over the network communications interface 433 to the control tower 130 from the GPS radios of the system 100. As discussed in greater detail below, determining the position of the control tower 130 can facilitate determining the position of the UAV 120 in flight.

The ADS-B radio 436 provides the microcontroller 431 real-time site air traffic information. The weather sensors 437 can include, for example, a temperature sensor, a pressure sensor, a wind sensor, and/or one or more other sensors configured to collect data pertinent to atmospheric flight conditions for the UAV 120. The camera 438 is configured to capture video or still images of all or a subset of the site of operation (e.g., all or a portion of the operational envelope of the UAV 120 proximate the control tower 130). As discussed in greater detail below, the video or images captured by the camera 438 can be (i) processed by the control tower 130 and/or by the flight manager 110 and (ii) used to identify (a) the UAV 120 and/or (b) objects (e.g., foreign objects) within the operational envelope that present a risk of colliding or otherwise interfering with the UAV 120. Similarly, the radar system 434 can include one or more radar antennae and can be configured to identify (a) the UAV 120 and/or (b) objects (e.g., foreign objects) within the operational envelope that present a risk of colliding with the UAV 120.

Furthermore, although not shown in FIG. 4, the control tower 130 in other embodiments of the present technology can include one or more other sensors and systems in addition to or in lieu of one or more of the sensors and system illustrated in FIG. 4. For example, the control tower 130 can include (i) an acoustic sensor or system that can identify and/or determine positional information related to aircraft or other objects by sound and/or (ii) a LIDAR sensor or system that can identify and/or determine positional information related to the aircraft or other objects using light. In these and other embodiments, the control tower 130 can lack one or more of the sensors and systems illustrated in FIG. 4. For example, the control tower 130 can lack the radar system 434 in some embodiments.

As discussed in greater detail below, the microcontroller 431 of the control tower 130 is also configured to receive, over the network communications interface 433, (a) environmental condition data related to the site of operation from one or more (e.g., all or a subset) of the navigation beacons 140, (b) data (e.g., positional, directional, altitude, pressure, and/or other data) from the UAV 120, and/or (c) UAV health and/or battery status information from the UAV inspection system 150. Environmental condition data received from the navigation beacons 140 can include, for example, (a) positional information captured by a GPS, (b) weather data captured by one or more weather sensors, and/or (c) video/image data captured by a camera of a corresponding navigation beacon 140. In some embodiments, the video or images captured by navigation beacon(s) 140 can be (i) processed by the control tower 130 and/or by the flight manager 110 and (ii) used to identify (a) the UAV 120 and/or (b) objects (e.g., foreign objects) within the operational envelope that present a risk of colliding with the UAV 120.

In some embodiments, the control tower 130 continuously collects environmental condition data using the GPS 435, the ADS-B radio 436, the weather sensors 437, the camera 438, and/or the radar system 434. In these and other embodiments, the control tower continuously receives environmental condition data from one or more navigation beacons 140 and/or from the UAV 120. In other embodiments, the control tower 130 periodically collects environmental condition data and/or the control tower 130 periodically receives environmental condition data from one or more of the navigation beacons 140 and/or the UAV 120. For example, the control tower 130 may be idle or passive until it is instructed by the flight manager 110 to enable various sensors or services of the control tower 130, of one or more beacons 140, of the UAV 120, and/or of the UAV inspection system 150.

Similarly, the control tower 130 can continuously or periodically (e.g., in response to instructions received from the flight manager 110) stream environmental condition data to the flight manager 110. As described in greater detail below, the flight manager 110 can receive the environmental condition data from the control tower 130 as inputs for making various flight-related decisions (e.g., emergency decisions) for the UAV 120. All or a subset of the environmental condition data received by the flight manager 110 can be stored, for example, in the system database 215 (FIG. 2).

The control tower 130 is deployed at a site of operation 103 (FIG. 1B). In some embodiments, electronics of the control tower 130 can be positioned approximately six to twelve meters above the ground or other obstacles to facilitate data collection and/or sufficient communication integrity between the control tower 130, the navigation beacons 140, the UAV 120, and/or the UAV inspection system 150. In some embodiments, the control tower 130 is battery-operated. In these and other embodiments, the control tower 130 includes one or more solar panels to charge the battery. Additionally, or alternatively, the control tower 130 can include a power cord configured to connect the control tower 130 to a power supply.

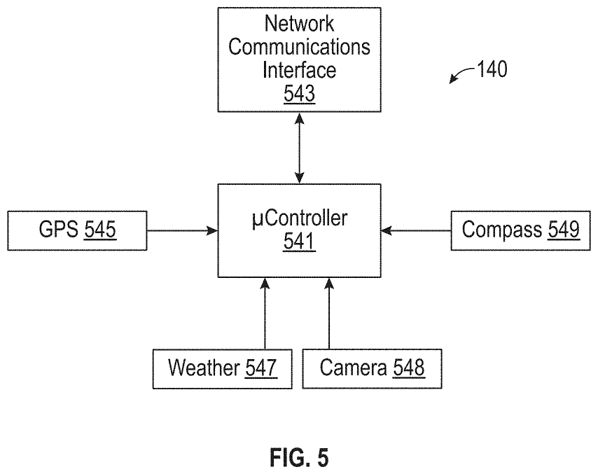

FIG. 5 is a block diagram of a navigation beacon 140 (e.g., one of the navigation beacons 140a-140d) of the system 100 (FIGS. 1A and 1B). As shown, the navigation beacon 140 includes a microcontroller 541 that interfaces with a network communications interface 543, a GPS 545, weather sensors 547, a camera 548, and a compass 549. In some embodiments, the network communications interface 543 is a LAN communications interface (e.g., a mesh network radio). In these embodiments, the navigation beacon 140 is configured to create a LAN (e.g., a mesh communications network) in conjunction with other navigation beacons 140 and the control tower 130 of the system 100, thereby facilitating communication between (a) the navigation beacon 140, the control tower 130 (FIGS. 1A, 1B, and 4), the UAV 120 (FIGS. 1A, 1B, and 3), and/or the UAV inspection system 150 (FIGS. 1A and 1B), and/or (b) any of these components and the flight manager 110 (via the control tower 130).

Although the navigation beacon 140 is illustrated as including only the network communications interface 543 in FIG. 5, a navigation beacon 140 configured in accordance with various embodiments of the present technology can include one or more other network communications interfaces in addition to or in lieu of the network communications interface 543. For example, a navigation beacon 140 in some embodiments can include a WAN communications interface (e.g., a broadband network radio) in addition to or in lieu of the network communications interface 543. This can enable the navigation beacon 140 to use the WAN communications interface to interface directly with the flight manager 110 (e.g., over the Internet) rather than requiring the navigation beacon 140 to interface with the flight manager 110 via the control tower 130.

The compass 549 can provide the orientation of the navigation beacon 140, and the GPS 545 can be used to determine positional information of the navigation beacon 140 using, for example, GNSS. The position of the navigation beacon can be transmitted to the control tower 130, to the flight manager 110, and/or to the UAV 120. As discuss in greater detail below, the known position of the navigation beacon 140 can be used as a point of reference for the UAV 120 to determine its location in space (e.g., using the UAV's 120 RF localization system). For example, the UAV 120 can calculate the RTT of a packet sent between the UAV 120 and the navigation beacon 140. Using the calculated RTT of the packet and the known location of the navigation beacon 140, the UAV 120 can calculate a distance between the UAV 120 and that navigation beacon 140. The UAV 120 is able to determine its position in space via trilateration using this distance in combination with two other distances calculated from (a) the RTTs of two other packets sent to one or more other navigation beacons 140 and/or the control tower 130, and (b) the known positions of the one or more navigation beacons 140 and/or the control tower 130, respectively. Thus, the navigation beacon 140 serves as a navigation aid to the UAV 120 to supplement the UAV's 120 onboard GPS unit. For this reason, navigation beacons 140 and the control tower 130 of the system 100 are positioned at a site of operation 103 (FIG. 1B) such that the UAV 120 can communicate with a number (e.g., one, two, three, or more) of navigation beacons 140 and/or control tower(s) 130 of the system 100 at any given time to enable the UAV 120 to accurately identify its position in space.

The weather sensors 547 of the navigation beacon 140 can include, for example, a temperature sensor, a pressure sensor, a wind sensor, and/or one or more other sensors configured to collect data pertinent to atmospheric flight conditions for the UAV 120. Data collected by one or more of the weather sensors 547 can be transmitted (e.g., streamed) to the control tower 130 and/or to the flight manager 110 in real-time, at set intervals, and/or in response to a command from the flight manager 110 and/or the control tower 130.

The camera 548 of the navigation beacon 140 is configured to capture video or still images of all or a subset of the site of operation (e.g., all or a portion of the operational envelope of the UAV 120 proximate the navigation beacon 140). Video or images captured by the camera 548 can be transmitted (e.g., streamed) to the control tower 130 and/or the flight manager 110 in real-time, at set intervals, and/or in response to a command received from the flight manager 110 and/or the control tower 130. As discussed in greater detail below, the video or images captured by the camera 548 can be (i) processed by the control tower 130 and/or by the flight manager 110, and (iii) used to identify (a) the UAV 120 and/or (b) objects (e.g., foreign objects) within the operational envelope that present a risk of colliding or otherwise interfering with the UAV 120.

Furthermore, although not shown in FIG. 5, the navigation beacon 140 in other embodiments of the present technology can include one or more other sensors and systems in addition to or in lieu of one or more of the sensors and systems illustrated in FIG. 5. For example, the navigation beacon 140 can include (i) an acoustic sensor or system that can identify and/or determine positional information related to aircraft or other objects by sound and/or (ii) a LIDAR sensor or system that can identify and/or determine positional information related to the aircraft or other objects using light. In these and other embodiments, the navigation beacon 140 can lack one or more of the sensors and/or systems illustrated in FIG. 5. For example, the navigation beacon 140 can lack all or a subset of the weather sensors 547 in some embodiments.

In some embodiments, the navigation beacon 140 continuously determines its location, collects weather data, and/or captures video/image data. In other embodiments, the navigation beacon 140 periodically determines its position, collects weather data, and/or captures video/image data. For example, the navigation beacon 140 may be idle or passive until it is instructed by the flight manager 110 or the control tower 130 to determine its position information, to collect weather data, to capture video/image data, and/or to communicate with the UAV 120. The navigation beacon 140 can capture video/image data for the entire duration of the UAV's 120 flight or for only a portion of the UAV's 120 flight (e.g., for only the portion of the UAV's 120 flight when the UAV 120 is within a threshold distance from the navigation beacon 140).

Similarly, the navigation beacon 140 can continuously or periodically (e.g., in response to instructions received from the flight manager 110 and/or the control tower 130) transmit (e.g., stream) its position information, weather data, and/or video/image data to the control tower 130 and/or to the flight manager 110. In the event the system 100 includes more than one control tower 130, instructions received by the navigation beacon 140 that direct the navigation beacon 140 to transmit data to a control tower 130 can specify to which control tower 130 of the system 100 the data is to be sent. As described in greater detail below, the flight manager 110 can use the position information, the weather data, and/or the video/image data for making various flight-related decisions (e.g., emergency decisions) for the UAV 120.

The navigation beacon 140 is deployed at a site of operation 103 (FIG. 1B). In some embodiments, electronics of the navigation beacon 140 can be positioned approximately two to three meters above the ground or other obstacles to facilitate data collection and/or sufficient communication integrity between the navigation beacons 140, the control tower 130, the UAV 120, and/or the UAV inspection system 150. In some embodiments, the navigation beacon 140 is battery-operated. In these and other embodiments, the navigation beacon 140 includes one or more solar panels to charge the battery. Additionally, or alternatively, the navigation beacon 140 includes a power cord configured to connect the navigation beacon 140 to a power supply.

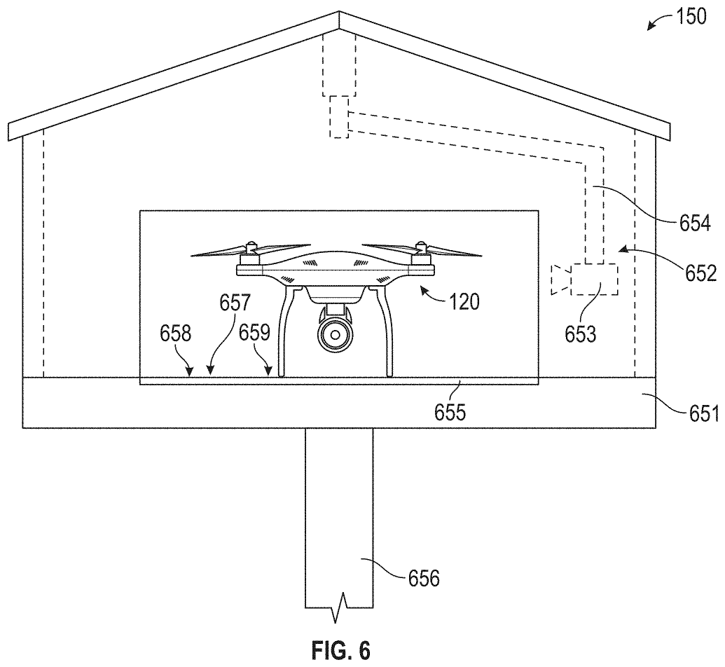

FIG. 6 is a partially schematic representation of a UAV inspection system 150 of the system 100 (FIGS. 1A and 1B). The UAV inspection system 150 includes an enclosure 651 that houses a visual scanning system 652 and a docking station 657. As shown, the enclosure 651 is also configured to house a UAV 120 (e.g., when the UAV 120 is positioned on the docking station 657). In some embodiments, the enclosure 651 protects or shelters the UAV 120 from environmental conditions at a site of operation 103 when the UAV 120 is not in flight. The enclosure 651 can be positioned on a pole or mount 656. This can facilitate positioning the enclosure off the ground and/or at various locations with different terrain topographies (e.g., flat or not flat) and/or other features (e.g., wet or swampy ground). Alternatively, the enclosure 651 can be positioned on the ground or on another surface (e.g., the roof of a building).

The visual scanning system 652 can include a camera 653 attached to or positioned on a mount or arm 654. In some embodiments, the visual scanning system 652 can include other components in addition to or in lieu of the camera 653 and/or the arm 654. For example, the visual scanning system 652 can include more than one camera 653 and/or more than one arm 654. In these and other embodiments, the visual scanning system 652 can include one or more light sources (not shown) configured to illuminate at least a portion of the UAV 120 when the UAV 120 is positioned on the docking station 657 and/or within the enclosure 651.

The arm 654 of the visual scanning system 652 in the illustrated embodiment is rotatable about the UAV 120 and/or the docking station 657. In these and other embodiments, the arm 654 can have a number of (e.g., one, two, three, four, five, and/or six) degrees of freedom to position the camera 653 at various locations and/or orientations about (e.g., the interior of) the enclosure 651. In other embodiments, such as in embodiments having multiple cameras 653, the arm 654 can be fixed and/or have a limited range of motion. As discussed in greater detail below, the camera 653 is configured to capture video and/or images of the UAV 120 at various positions about the UAV 120 that can be used to assess the health of the UAV 120.

The docking station 657 of the UAV inspection system 150 includes a landing pad 658 and a wireless (e.g., induction) charging pad 659. In some embodiments, the landing pad 658 is extendable from within an interior of the enclosure 651 to an exterior of the enclosure 651. For example, the enclosure 651 can include a flap or door 655 that can open allowing the landing pad 658 to extend outside of the enclosure (e.g., to facilitate the UAV 120 taking off from and/or landing on the landing pad 658). Additionally, or alternatively, the landing pad 658 can be retractable from the exterior of the enclosure 651 to within the interior of the enclosure 651 (e.g., to position the UAV 120 within the enclosure 651 and/or proximate the visual scanning system 652). In other embodiments, the landing pad 658 is stationary, and the UAV 120 can be (e.g., autonomously) maneuvered to position the UAV 120 on the landing pad 658 and within the enclosure 651. The door 655 of the enclosure 651 can close when the landing pad 658 and/or the UAV 120 are within the interior of the enclosure 651. Alternatively, the enclosure 651 can lack a door 655 in some embodiments.

In operation, the UAV inspection system 150 is configured to (e.g., autonomously) inspect the UAV 120 (e.g., pre-flight) using the visual scanning system 652 to assess aircraft integrity. For example, the UAV inspection system 150 can use the visual scanning system 652 to capture one or more baseline videos and/or images of the UAV 120 (e.g., when the UAV inspection system 150 and/or the UAV 120 is first deployed at the site of operation). In these and other embodiments, the UAV inspection system 150 can use the visual scanning system 652 to capture one or more subsequent videos and/or images of the UAV 120 (e.g., prior to the UAV 120 executing a flight plan). The UAV inspection system 150 and/or the flight manager 110 can compare the subsequent video and/or images to the baseline video and/or images to assess the health of the UAV 120 and/or to identify potential damage to the UAV 120.

The landing pad 658 of the docking station 657 provides the UAV 120 a location to land and await a flight plan from the flight manager 110. The wireless charging pad 659 of the docking station 657 can wirelessly charge one or more of the UAV's 120 onboard batteries for a future flight when the UAV 120 is positioned on or over the landing pad 658. In other embodiments, the UAV inspection system 150 and/or the docking station 657 can include other equipment for recharging the UAV's 120 onboard batteries in addition to or on in lieu of the wireless charging pad 659. For example, in some embodiments, the landing pad 658 can include one or more contact pads that are put in electrical communication with the UAV's 120 onboard batteries when the UAV 120 is physically positioned on the landing pad 658.

In some embodiments, the UAV inspection system 150 includes one or more network communications interfaces (not shown). For example, the UAV inspection system 150 can include a LAN communications interface (e.g., a mesh network radio) and/or a WAN communications interface (e.g., a broadband network radio). The LAN communications interface can enable the UAV inspection system 150 to communicate with the UAV 120, the control tower 130, the navigation beacons 140, and/or the flight manager 110 (e.g., via the control tower 130). The WAN communications interface can enable the UAV inspection system 150 to communicate directly with the flight manager 110. In this manner, the UAV inspection system 150 can report battery and/or health status data related to the UAV 120 to the control tower 130 and/or to the flight manager 110. As part of the battery and/or health status data, the UAV inspection system 150 can provide the control tower 130 and/or the flight manager 110 an indication of whether the UAV 120 is flightworthy to execute a flight plan.

In some embodiments, the UAV inspection system 150 can include one or more components in addition to or in lieu of one or more components illustrated in FIG. 6. For example, the UAV inspection system 150 can include another type of inspection system, such as a non-visual inspection system in addition to or in lieu of the visual scanning system 652. In these and other embodiments, the UAV inspection system 150 can include one or more additional docking stations 657 and/or visual inspection systems 652 such that the enclosure 651 can house (and the UAV inspection system 150 can inspect) more than one UAV 120.

2. Associated Methods

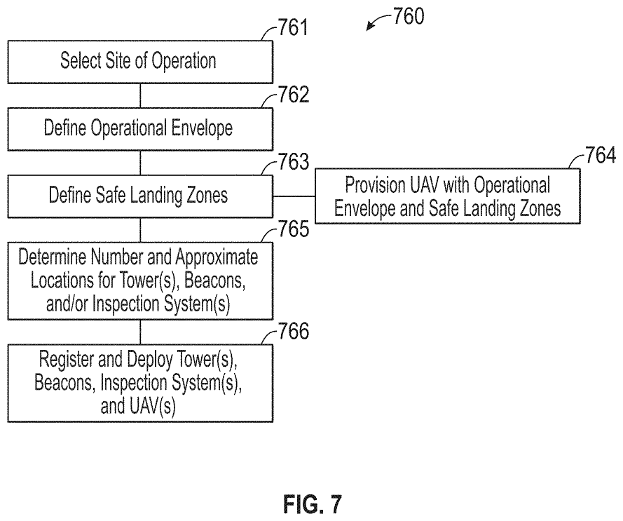

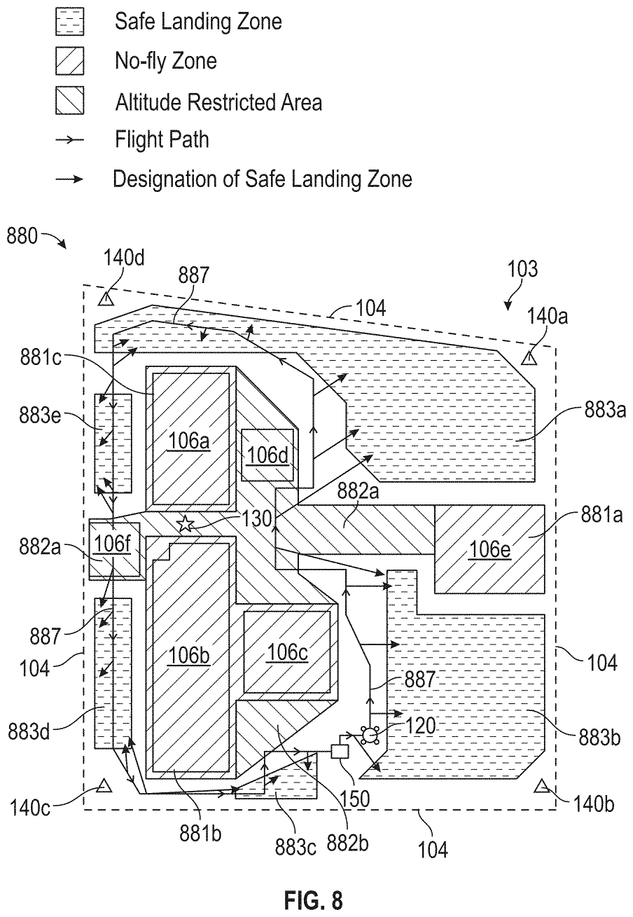

FIG. 7 is a flow diagram illustrating a method 760 of defining an operational envelope and/or one or more safe landing zones for a UAV, and/or of deploying an autonomous UAV operational containment system at a site of operation, in accordance with various embodiments of the present technology. All or a subset of the steps of the method 760 can be executed by various components or devices of an autonomous UAV operational containment system, such as the system 100 illustrated in FIGS. 1A and 1B or other suitable systems. For example, all or a subset of the steps of the method 760 can be executed by (i) components or devices of the flight manager 110 (FIGS. 1A, 1B, and 2), (ii) components or devices of the UAV 120 (FIGS. 1A, 1B, and 3), (iii) components or devices of the control tower 130 (FIGS. 1A, 1B, and 4), (iv) components or devices of the navigation beacons 140 (FIGS. 1A, 1B, and 5), and/or (v) components or devices the UAV inspection system 150 (FIGS. 1A, 1B, and 6). Additionally, or alternatively, all or a subset of the steps of the method 760 can be executed by a user (e.g., an operator, a service technician, and/or a field technician) of the system 100. Furthermore, any one or more of the steps of the method 760 can be executed in accordance with the discussion above. For the sake of clarity and explanation, the method 760 is discussed in part below with occasional reference to FIG. 8, which is a partially schematic diagram of a user interface 880 illustrating the example site of operation 103 of FIG. 1B. As discussed in greater detail below, a user can utilize the user interface 880 to define an operational envelope and/or safe landing zones for a UAV 120 at the site of operation 103, and/or to deploy components of a UAV operational containment system at the site of operation 103.

The method 760 begins at block 761 by selecting a site of operation for an autonomous UAV operational containment system (“the system”). A user can select a site of operation using a user interface presented to the user via, for example, a webserver portal (e.g., the webserver portal 219 of FIG. 2) of a flight manager of the system. In response, the user interface can present the user a map (e.g., a street map, a topographical map, a two-dimensional or three-dimensional map, a satellite image, and/or another suitable map) of the selected site of operation. Referring to FIG. 8 as an example, when the user selects the site of operation 103 illustrated in FIG. 1B, the system 100 can present the user a satellite image of the site of operation 103 within the user interface 880. Buildings 106a-106d, a parking lot 106e, and other infrastructure 106f within the site of operation 103 can be visible within this satellite image. Streets, walkways, and other features (e.g., trees, terrain topology, terrain geometry, and/or other features) of the site of operation may also be visible in the map presented to the user. In some embodiments, property boundaries lines 104 for the site of operation 103 can be automatically populated (e.g., using data retrieved from property records) in the map. In other embodiments, the user can define the property boundaries at block 762.

At block 762, the method 760 continues by defining an operational envelope for a UAV of the system. The operational envelope is the air space within the site of operation in which the UAV is permitted to fly. By default, the operational envelope can be defined as a three-dimensional polygon or shape limited by the property boundaries of the site of operation and an altitude of approximately 122 meters (or another altitude set by a regulating body and/or representing a maximum UAV altitude operating limit). As discussed above, the property boundaries of the site of operation can be automatically populated within a map of the site of operation when the user selects the site of operation at block 761. Alternatively, the user can identify or set the property boundaries for the site of operation at block 762. In either case, the user can edit the property boundaries and/or the altitude operating limits for the site of operation presented in the user interface. For example, a user can edit the legal property boundaries of the site of operation inward to avoid known obstructions about the perimeter of the site of operation and/or to create a buffering no-fly zone along all or a subset of the perimeter of the site of operation.

In some embodiments, the user may edit the operational envelope based at least in part on known site constraints, such as infrastructure or other features (e.g., trees, terrain topology, terrain geometry, and/or other features). This may include defining no-fly zones and/or altitude restricted areas. A no-fly zone is a zone identified within the site of operation that stretches from the ground (or lower) to the highest altitude operating limit for the UAV. As such, a UAV is prohibited from flying over or under no-fly zones and must instead fly around them. By contrast, an altitude restricted area is a zone identified within the site of operation that is limited to one or more specific ranges of altitudes. As such, a UAV is permitted to fly over and/or under an altitude restricted area at altitudes outside of the specified range(s) that define the altitude restricted area, and to fly around the altitude restricted area.

Referring to FIG. 8, for example, the user may define no-fly zones 881 (identified individually as no-fly zones 881a-881c in FIG. 8) around critical infrastructure (e.g., buildings 106a-106c and parking lot 106e), areas in which humans are known to commonly congregate, and/or other areas. Thus, a UAV deployed at the site of operation 103 and provided with the operational envelope parameters is prohibited from flying over the buildings 106a-106c and the parking lot 106e at any altitude. Additionally, or alternatively, the user may define altitude restricted areas 882 (identified individually as altitude restricted areas 882a and 882b in FIG. 8) over or around infrastructure (e.g., over non-critical building 106d and other infrastructure 106f, around or between portions of buildings 106a-106d, and/or over or around other infrastructure, such as a crane temporarily set up at the site of operation) or other features (e.g., trees, walkways, and/or other features). Here, the altitude restricted areas 882a and 882b are limited to altitudes ranging from an altitude corresponding to the ground (or lower) and maximum altitudes set by the user. Thus, a UAV deployed at the site of operation 103 and provided with the operational envelope parameters is permitted to fly over the altitude restricted areas 882a and 882b and over building 106d and other infrastructure 106f, but only at altitudes above the maximum altitudes set by the user.

In some embodiments, all editing of the property boundaries, no-fly zones, and/or altitude restricted areas is performed via additive and subtractive polygons or shapes in the user interface. For example, a user can draw or otherwise define/identify (a) perimeter boundaries, (b) maximum and/or minimum permitted altitude operating limits, (c) no-fly zones, and/or (d) altitude restricted areas in the user interface. Additionally, or alternatively, the user can specify start and stop altitudes for the perimeter boundaries, no-fly zones, and/or altitude restricted areas such that the perimeter boundaries, no-fly zones, and/or altitude restricted areas are defined as three-dimensional polygons or shapes that limit the operational envelope for a UAV. Thus, the operational envelope for a UAV can be limited to be within the perimeter boundaries (e.g., to be within the property boundaries and/or other user-defined boundaries) of the site of operation and outside of the no-fly zones and altitude restricted areas. Furthermore, a user can remove perimeter boundaries, no-fly zones, and/or altitude restricted areas (e.g., in the event that temporary infrastructure, such as a crane, has been removed from the site of operation) by removing the corresponding polygon or shape in the user interface, thereby expanding the operational envelope of the UAV to include the corresponding section of airspace at the site of operation.

In some embodiments, operational envelope parameters defined at block 762 of the method 760 can correspond to a specific UAV at the site of operation. For example, a user can define a first operational envelope for a first UAV that is or will be deployed at the site of operation and a second operational envelope for a second UAV that is or will be deployed at the site of operation. The first and second operational envelopes can be the same or can differ. As another example, a user can define an operational envelope for a first region at the site of operation, and the operational envelope for the first region can be associated with a UAV that is or will be deployed at the site of operation to execute flight plans within the first region. Continuing with this example, the user can additionally or alternatively define an operational envelope for a second region (e.g., a region different and/or separate from the first region) at the site of operation, and the operational envelope for the second region can be associated with another UAV that is or will be deployed at the site of operation to execute flight plans within the second region.

At block 763, the method 760 continues by defining safe landing zones for a UAV within the operational envelope defined at block 762. A safe landing zone is an area in which the UAV can land or attempt to land in the event of an in-flight emergency (e.g., to avoid critical infrastructure, humans, and/or vehicles). A user may identify and/or define safe landing zones in the user interface (e.g., by drawing, outlining, or otherwise marking the safe landing zones on the map of the site of operation). Any safe flat area with no obstructions or human traffic is encouraged (and may be recommended via the user interface) as a safe landing zone to provide as much coverage as possible for any potential flight paths of the UAV. For example, the flight manager can (i) evaluate the operational envelope defined at block 762 to identify grass, concrete, and/or other areas clear of buildings, vehicles, and/or other obstructions, and (ii) generate and display polygons or shapes over these areas in the user interface to present a user with suggested safe landing zones within the operational envelope. The user can then alter, delete, and/or confirm the polygons or shapes as safe landing zones.

Referring to FIG. 8 again as an example, a user has defined five safe landing zones 883 (identified individually as safe landing zones 883a-883e in FIG. 8) on the user interface within the operational envelope defined at the site of operation 103. As shown, the safe landing zones 833a-883e collectively cover a large portion of a floor of the operational envelope. This can increase the chances of a UAV successfully landing within one of the safe landing zones 833a-833e in the event of an in-flight emergency, regardless of the UAV's position along a flight path extending anywhere within the operational envelope.

For example, a flight path 887 is shown in FIG. 8 that starts from a UAV inspection system 150, loops around the buildings 106a-106d, and returns to the UAV inspection system 150. As described in greater detail below, a UAV 120 executing a flight plan that uses the flight path 887 can, in the event of an in-flight emergency, attempt to land at whichever of the safe landing zones 883a-883e is nearest to the position of the UAV 120 along the flight path 887 at the time the UAV 120 experiences the in-flight emergency. As shown by the arrows in FIG. 8 that extend from the flight path 887 to various ones of the safe landing zones 883a-883e, the large coverage collectively provided by the safe landing zones 883a-883e means that the UAV 120 is not required to traverse large distances from the flight path 887 to one of the safe landing zones 883a-833e regardless of the UAV's 120 position along the flight path 887 at the time the UAV 120 experiences the in-flight emergency. This can increase the chances that the UAV 120 successfully lands within one of the safe landing zones 883a-883e while decreasing the chance that the UAV 120 collides with critical infrastructure or humans/vehicles on the ground.

At this point, the operational envelope for a UAV at the site of operation and the safe landing zones within the operational envelope are defined. Although the site of operation 103, infrastructure 106a-106f, no-fly zones 881a-881c, altitude restricted areas 882a and 882b, safe landing zones 883a-883e, and the flight path 887 are illustrated in FIG. 8 with straight lines and/or are generally rectangular, the present technology is not so limited. For example, that site of operation can have any other size or shape, and any other polygons or shapes (e.g., two-dimensional or three-dimensional polygons or shapes, including those based on curves or free form lines) can be used in some embodiments to define the operational envelope and/or the safe landing zones therein.

At block 764, the method 760 continues by providing each of the UAVs deployed at the site of operation with the operational envelope and safe landing zone parameters. As discussed in greater detail above with respect to FIG. 3, these parameters can be secured and provided to both the flight controller and the oversight processor of each UAV of the system (e.g., pre-flight) such that each UAV is constrained (via the multi-processor architecture of the UAV) to operate only with the operational envelope and is aware of the locations of safe landing zones within the operational envelope at all times. For example, the parameters can be encrypted and/or saved to non-volatile memory onboard the UAV or removable from the UAV (e.g., via an SD card or other removable memory).

In some embodiments, the flight controller and/or the oversight processor of a UAV can be factory provided with secure credentials (e.g., with public key infrastructure (PKI) credentials) to create unique credential identities for the UAV, the flight controller, and/or the oversight processor. In these embodiments, the operational envelope and safe landing zone parameters can be encrypted such that the parameters can be decrypted by only a processor (e.g., the flight controller or the oversight processor) and/or by only a UAV having a specified credential identification.

At block 765, the method 760 continues by determining the number and approximate locations of control towers, navigation beacons, and/or UAV inspection systems for deployment at the site of operation. The number and approximate locations of control towers and navigation beacons suggested can be based at least in part on an expectation that the entire site of operation (or at least the entire operational envelope at the site of operation) is blanketed with adequate network and localization coverage. In some embodiments, the system requires (a) a control tower to facilitate communications between the flight manager and various devices of the system deployed at the site of operation, and (b) three navigation components (comprising control towers and/or navigation beacons) for the RF localization systems of the UAVs to use trilateration to determine the positions of the UAVs. In these embodiments, the number and approximate locations of control towers and navigation beacons recommended can therefore be based at least in part on these considerations to increase the likelihood that the requirements of those embodiments are met.

In these and other embodiments, the number and approximate locations of control towers and/or navigation beacons can depend at least in part on the specifications of hardware implemented in the control towers and/or in the navigation beacons. As a specific example, the control towers and navigation beacons configured in accordance with various embodiments of the present technology can include radios (e.g., 900 MHz radios) having a range of approximately 3.2 km. Therefore, the number and approximate locations of the towers and/or navigation beacons can be initially determined using an infinite unobstructed plane to create a geometric (e.g., rectangular, triangular, hexagonal, and/or suitable polygon or shape) repeating layout (or grid) with a certain number of towers or beacons per unit area (e.g., at least one navigation beacon or control tower every 3.2 km). An initial deployment layout of control towers and/or navigation beacons at the site of operation can be generated by overlaying the grid over a representation (e.g., a two-dimensional or topographical representation) of the site of operation and providing (i) that a minimum of at least one control tower and at least two navigation beacons covers the operational envelope and (ii) that the UAV can communicate with at least three components (comprising control towers and/or navigation beacons) at any point within the operational area such that the RF localization system of the UAV can determine the position of the UAV in space. The scale of the geometric repeating layout can be changed based on radio performance. In these and other embodiments, the suggested number and/or approximate locations of the control towers and/or navigation beacons can be based at least in part on infrastructure, features (e.g., trees, terrain topology, terrain geometry), and/or other obstacles located within the site of operation.

In these and still other embodiments, the number and approximate locations of control towers and/or navigation beacons can depend at least in part on sensors or systems included on these devices. For example, the control towers may include one or more sensors or systems (e.g., ADS-B, radar, and/or other equipment) that are not included in the navigation beacons. As a specific example, assuming that the radar system of the control tower has the most limited range (e.g., approximately 16 km) of all the sensors or systems included in the control tower but not included in the navigation beacons, then the number and approximate locations of control towers and/or navigation beacons can be determined such that a control tower is positioned at least every 16 km (e.g., instead of a navigation beacon). This can increase the likelihood of continuous monitoring of air traffic using the radar system of the control towers across the entire site of operation (or at least the entire operational envelope at the site of operation).

In these and other embodiments, the recommended number and approximate locations of control towers and/or navigation beacons can be based at least in part on other considerations. For example, for smaller sites of operation, the recommended location for a control tower can be the center of the site of operation such that UAVs of the system operating within the operational envelope remain within the fields of view of one or more cameras of the control tower and/or within the range of the radar system of the control tower. As another example, the recommended location for a control tower can be a location of a building or other infrastructure within the site of operation that offers a wired network connection, obviating reliance on rural and/or wireless networks at the site of operation. As yet another example, the recommended location for at least some of the navigation beacons can be along the perimeter of the site of operation and/or the operational envelope. This can increase the likelihood that UAVs operate within (as opposed to outside of) a cluster of navigation beacons and/or control towers, which improves accuracy of calculations performed by the RF localization systems of the UAVs when determining the position of the UAV using navigation beacons and/or control towers of the cluster. The system can, of course, recommend positioning the control tower(s) and/or the navigation beacons at other locations than the center and/or perimeter of the site of operation.

The number of UAV inspection systems recommended for deployment at the site of operation can depend on the number of UAVs that are deployed to the site operation. For example, as the number of UAVs deployed at the site of operation increases, the number of UAV inspection systems recommended for deployment at the site of operation can also increase. The recommended locations for the UAV inspection systems are locations within the site of operation that are safely distanced apart from critical infrastructure or common congregation points at the site of operation but that can be conveniently accessed in the event the UAV inspection systems and/or the UAVs need servicing. The recommended locations for the UAV inspection systems can also be based at least in part on proximity to areas within the operational envelope of the site of operations that UAVs of the system will frequent when executing a scheduled flight plan.

In some embodiments, the number and approximate locations of the control towers, the navigation beacons, and/or the UAV inspection systems are recommended to the user via the user interface. For example, referring to FIG. 8, the system can recommend deploying a single control tower 130 at a central location within the site of operation and deploying four navigation beacons 140a-140d along the perimeter of the site of operation. The system can additionally, or alternatively, recommend positioning a UAV inspection system at a location within the site of operation that is (a) apart from critical infrastructure 106a-106c and 106e, (b) flat, (c) surrounded by adequate safe landing zones, and/or (d) readily accessible by a service technician.

At block 766, the method 760 continues by registering control towers, navigation beacons, UAVs, and/or UAV inspection systems to the site of operation and deploying these components at the site of operation. For example, a field deployment team can retrieve the recommended number of control towers, navigation beacons, UAVs, and/or UAV inspection systems from inventory and register them to the site of operation (e.g., by scanning Quick Response (QR) codes on the devices). Registering the devices ties the devices with the user's account in the flight manager of the system and to the site of operation such that the devices are recognized as operational components of the system within the site of operation.

Continuing with this example, the field deployment team can deploy the devices using the recommendation generated at block 765 as a map of the system layout. The map, however, can be merely a guideline in some embodiments. Thus, the field deployment team can deploy a different number of devices and/or devices at locations other than shown on the map (e.g., based at least in part on (a) infrastructure, features (e.g., trees, terrain topology, terrain geometry), and/or other obstacles located within the site of operation, (b) hardware performance in the field, and/or (c) network connectivity). For example, the field deployment team can use a localization device to (i) walk at least the operational envelope at the site of operation, (ii) identify areas where there is not adequate coverage, and (iii) add additional control towers and/or navigation beacons as needed.

Once the devices are deployed and powered up, the devices are placed into communication with the flight manager. Each device having an onboard GPS system reports its exact location within the site of operation to the flight manager, providing the flight manager a highly accurate site map. The field deployment team then performs a final check to assess continuous connectivity and localization capabilities across the entire site of operation (or at least the entire operational envelope within the site of operation). If errors occur during the final check, the field deployment team takes corrective action (e.g., troubleshooting, deploying additional devices, and/or other appropriate actions) until the system passes the final check. The system is now ready to execute flight plans.

Although the steps of the method 760 are discussed and illustrated in a particular order, the method 760 illustrated in FIG. 7 is not so limited. In other embodiments, the method 760 can be performed in a different order. In these and other embodiments, any of the steps of the method 760 can be performed before, during, and/or after any of the other steps of the method 760. Moreover, a person of ordinary skill in the relevant art will recognize that the illustrated method 760 can be altered and still remain within these and other embodiments of the present technology. For example, one or more steps of the method 760 illustrated in FIG. 7 can be omitted and/or repeated in some embodiments.

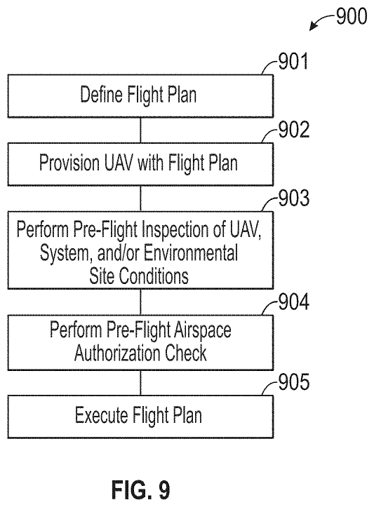

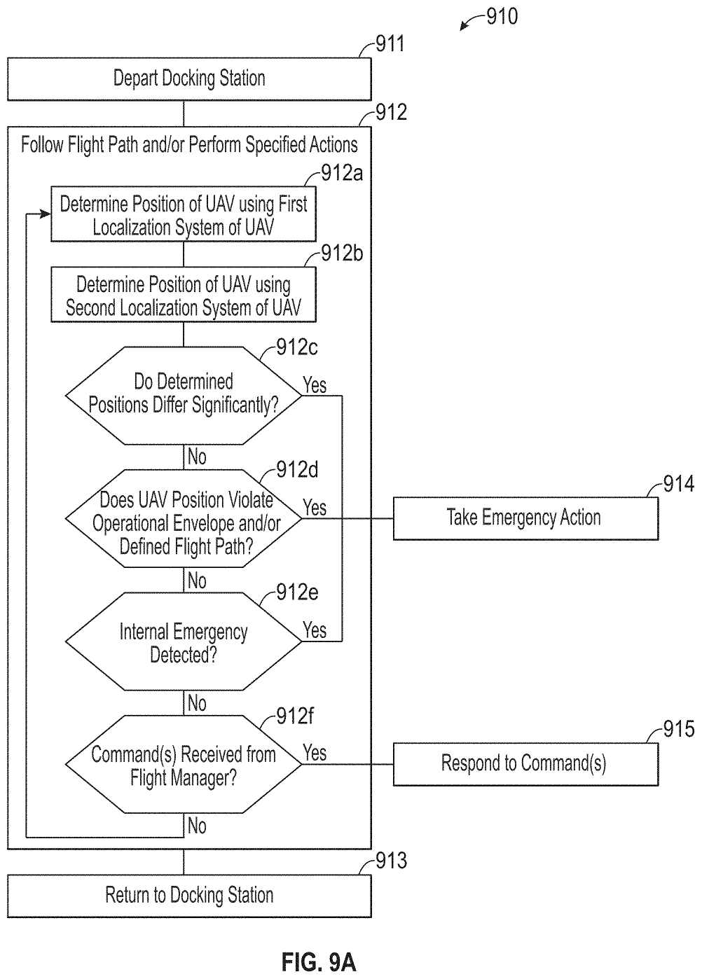

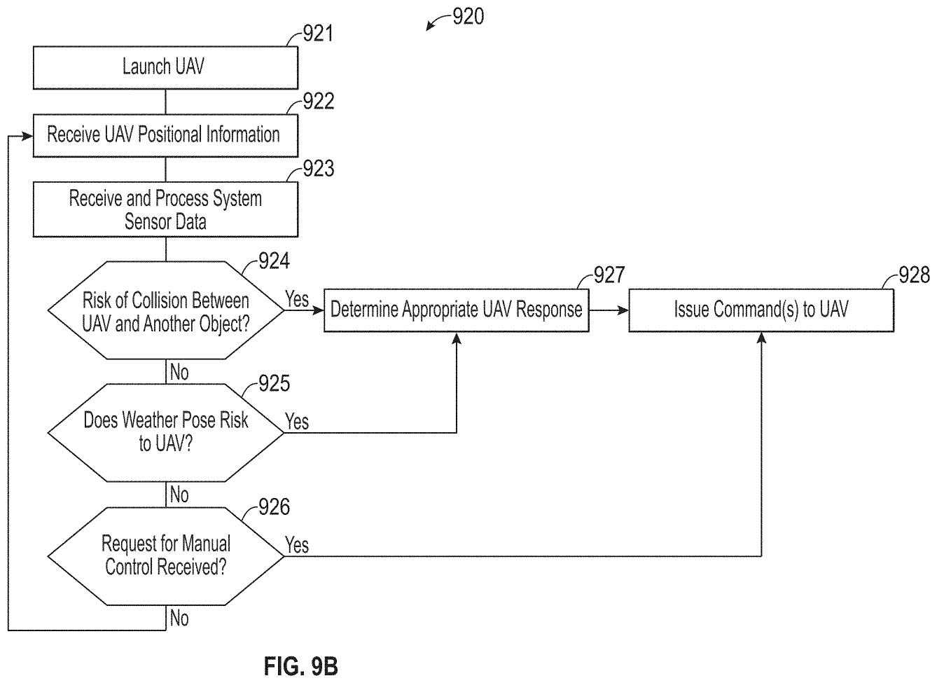

FIG. 9 is a flow diagram illustrating a method 900 of operating an autonomous UAV operational containment system in accordance with various embodiments of the present technology.

All or a subset of the steps of the method 900 can be executed by various components or devices of an autonomous UAV operational containment system (“the system”), such as the system 100 illustrated in FIGS. 1A and 1B or other suitable systems. For example, all or a subset of the steps of the method 900 can be executed by (i) components or devices of the flight manager 110 (FIGS. 1A, 1B, and 2), (ii) components or devices of the UAV 120 (FIGS. 1A, 1B, and 3), (iii) components or devices of the control tower(s) 130 (FIGS. 1A, 1B, and 4), (iv) components or devices of the navigation beacon(s) 140 (FIGS. 1A, 1B, and 5), and/or (v) components or devices the UAV inspection system 150 (FIGS. 1A, 1B, and 6). Additionally, or alternatively, all or a subset of the steps of the method 900 can be executed by a user (e.g., an operator, a service technician, and/or a field technician) of the system 100. Furthermore, any one or more of the steps of the method 900 can be executed in accordance with the discussion above. For the sake of clarity and explanation, the method 900 is discussed in part below with occasional reference back to FIG. 8, which is a partially schematic diagram of a user interface 880 illustrating the example site of operation 103 of FIG. 1B. As discussed in greater detail below, a user can utilize the user interface 880 to create a flight plan for a UAV of the system.

The method 900 begins at block 901 by creating a flight plan. In some embodiments, a user logs into the flight manager of the system (e.g., via the webserver portal of the flight manager) and (in the event that more than one UAV is deployed to the site of operation) selects a UAV deployed at the site of operation. For example, the user can select a UAV assigned to a specific region within the site of operation. The user then creates a flight plan for the UAV using a user interface (e.g., the user interface 880 of FIG. 8). For example, the user interface can present the user a map (e.g., a street map, a topographical map, a two-dimensional or three-dimensional map, a satellite image, and/or another suitable map) of a site of operation. The map presented can illustrate property boundaries and/or various boundaries or zones (e.g., perimeter boundaries, no-fly zones, altitude restricted areas, and/or safe landing zones) of an operational envelope (e.g., defined at block 761-763 of the method 760 illustrated in FIG. 7) for the UAV. For example, referring to FIG. 8, the user can create a flight plan using the user interface 880 in which a map of the site of operation 103 is presented. The user interface 880 can also include representations of known locations of the control tower 130, the navigation beacons 140a-140d, the UAV 120, and/or the UAV inspection system 150; and/or an illustration of the operational envelope of the UAV 120 defined by the no-fly zones 881a-881c, the altitude restricted areas 882a and 882b, and/or the safe landing zones 883a-883e.

To create the UAV flight plan, a user defines a flight path, approves an emergency flight plan corresponding to the defined flight path, defines UAV actions during execution of the flight plan, and/or sets a schedule for execution of the flight path. The flight path is a vectorized path in three dimensions for the UAV to follow. In some embodiments, the user can draw or otherwise input (e.g., upload, select a flight plan/path previously defined and saved in memory, and/or otherwise specify) a proposed flight path within the user interface. In these and other embodiments, the user can specify an altitude of the UAV for all or a subset (e.g., individual segments) of the proposed flight path. The user can adjust, move, remove, redraw, or otherwise alter all or a portion of the flight path previously drawn into the user interface. Referring to FIG. 8, a user has defined a flight path 887 that starts from a UAV inspection system 150, loops around the buildings 106a-106d, and returns to the UAV inspection system 150.

The flight manager verifies that a flight path defined by the user does not violate the operational envelope of the UAV. In some embodiments, the flight manager can reject and/or flag all or a subset (e.g., individual segments) of the proposed flight path that violates the operational envelope defined for the UAV. For example, if a segment of the flight path (a) enters a no-fly zone, (b) enters an altitude restricted area (e.g., by specifying an altitude for the UAV within the altitude restricted area), or (c) extends beyond a property boundary for the site of operation and/or a perimeter boundary of the operational envelope, the flight manager can reject and/or flag (e.g., highlight or otherwise emphasize) the flight path and/or the violating portion of the flight path in the user interface. The user can then adjust, move, remove, redraw, or otherwise alter one or more segments of the flight path, such as the segments of the flight path in violation of the operational envelope of the UAV.

Once a flight path has been defined (in whole or in part), an emergency flight plan corresponding to the flight path can be (e.g., automatically) generated. In some embodiments, the emergency flight plan specifies, for every point or segment of the defined flight path, a safe landing zone and/or an emergency flight path to the safe landing zone. Thus, if (i) the UAV experiences an in-flight emergency at a specific point or segment of the flight path and (ii) the emergency necessitates that the UAV lands immediately, the UAV can execute the emergency flight plan by navigating along the emergency flight path corresponding to the specific point or segment and/or by attempting to land at a safe landing zone designated to the specific point or segment designated in the emergency flight plan. In some embodiments, the designated safe landing zone is the closest safe landing zone to that point. In these and other embodiments, the designated safe landing zone is the closest safe landing zone to a segment of the flight path including that point. In these and still other embodiments, the safe landing zone for the point or segment is determined based at least in part on one or more other factors or consideration, such as ensuring that the UAV's attempt to land at a designated safe landing zone does not include the UAV flying over critical infrastructure, dropping to altitudes within altitude restricted areas, and/or otherwise violating the UAV's operational envelope.

In some embodiments, the user (in addition to or in lieu of the flight manager) can manually specify the safe landing zones for segments and/or points of the flight path. For example, referring to FIG. 8, arrows are shown extending from the defined flight path 887 to one of the safe landing zones 883a-883e to illustrate which of the safe landing zones 883a-883e have been designated in the emergency flight plan for each point/segment of the flight path 887. These arrows can be drawn or otherwise specified/entered into the user interface by the user. Additionally, or alternatively, the flight manager can initially designate one of the safe landing zones 883a-883e to every point and/or segment along the flight path 887 and can present the user a representation of the emergency flight plan (e.g., using the arrows) within the user interface 880. The user can modify or confirm one or more of the flight manager's suggestions via the user interface 880. For example, for points along the bottommost segment of the flight path 887 illustrated in FIG. 8, the flight manager can initially suggest designating the safe landing zone 883d in the emergency flight plan. Noticing that for at least some of the points along this segment of the flight path 887 the flight manager's suggestion would entail the UAV flying over critical infrastructure (the building 106b) at the site of operation 103, the user can modify the designated safe landing zone for at least some of the points along this segment from the safe landing zone 883d to the safe landing zone 883c to, for example, avoid the UAV flying over the building 106b even though the safe landing zone 883d may be closer to the points along this segment of the flight path 887 than the safe landing zone 883c (at least as the crow flies). Although the emergency flight paths illustrated in FIG. 8 are shown as straight lines extending from the flight path 887 to one of the safe landing zones 883a-883e, the disclosure is not so limited. The emergency flight paths need not be straight lines. For example, the emergency flight paths can be curves and/or can include multiple segments (e.g., to avoid critical infrastructure at the site of operation 103).

In some embodiments, a user can specify UAV actions for all or a portion of the flight plan. For example, the user can specify that a UAV should capture video/image data during flight along all or identified subset(s) of the defined flight path. Continuing with this example, the user can specify in which direction or at which object of interest the UAV should direct the field of view of the camera during periods of video/image data capture.

In these and other embodiments, the user can set a schedule for execution of the flight plan. For example, the user can specify a specific date and time for the UAV to execute the flight plan. In these and other embodiments, the user can specify whether the flight plan is to be executed once or whether the flight plan is to be executed multiple times. If multiple times, the user can specify the recurrence schedule for execution of the flight plan. In these and still other embodiments, the user can launch the UAV on demand at any time when the user is logged into the webserver portal and/or after the flight plan has been created.

At block 902, the method 900 continues by providing the UAV with the flight plan. In some embodiments, the UAV securely downloads the flight plan from the flight manager (e.g., over the mesh network via the control tower and/or the navigation beacons, and/or over another network, such as over a broadband network that facilitates direct communication between the flight manager and the UAV). In these and other embodiments, the flight plan can be saved to removable memory (e.g., an SD card) and provided (e.g., inserted into) the UAV, or can otherwise be provided to the UAV.

At block 903, the method 900 continues by performing a pre-flight inspection of the UAV, the system, and/or environmental site conditions. In some embodiments, the pre-flight inspection of the UAV is performed at least in part by the UAV inspection system. For example, the UAV inspection system retrieves battery status data for the UAV and/or captures one or more two-dimensional and/or three-dimensional images of the UAV. The battery status data and/or the image data is transmitted to the flight manager. The flight manager compares the battery status data to a minimum flight execution battery status threshold (e.g., for the flight plan) and/or compares the image data of the UAV to historical (e.g., baseline) image data of the UAV. If the flight manager determines that the battery status data is below the minimum threshold and/or that differences exist between the new image data and the historical image data of the UAV that are representative of damage on the UAV, the UAV is prevented from executing the flight plan. In the event damage is identified, a notification can be sent to a service technician. In some embodiments, the UAV operational containment system does not include a UAV inspection system, or the UAV inspection system includes only a docking station for the UAV. In these embodiments, a human can perform a visual inspection of the UAV and can notify the flight manager whether the UAV is flightworthy to execute a flight plan. Additionally, or alternatively, if the UAV fails the pre-flight inspection and there is a backup UAV of the system available that passes the pre-flight inspection, the flight plan can be provided to the backup UAV for execution of the flight plan by the backup UAV.

The pre-flight system inspection determines that all components (e.g., the control tower, the navigation beacons, the UAV inspection system, and/or the UAV) are operational and in communication with (e.g., the MQTT server of) the flight manager before a flight plan is executed. For example, prior to execution of the flight plan (e.g., five minutes before execution), the flight manager queries the control tower, the navigation beacons, the UAV inspection system, and/or the UAV for their positions. In response to this inquiry, the components exit a low power hibernation state and/or transmit their positional information (e.g., their GPS positional information) to the flight manager. In some embodiments, the control tower enables RTK GNSS (e.g., in response to a command received from the flight manager). This positional check determines that the components of the system are all successfully connected to the flight manager and that the flight manager has accurate positional information for the components (eliminating, for example, the concern that one of the components has been moved since a last positional check). If one of the components of the system fails to respond to the inquiry, a notification can be sent to a field technician to investigate. In these and other embodiments, unless all components (e.g., the control tower, the navigation beacons, the UAV inspection system, and/or the UAV) are online and in communication with the flight manager by the start of execution of the flight plan, the UAV is prohibited from executing the flight plan until the problem is remedied. In some embodiments, the flight manager provides the UAV (e.g., via a control tower and/or a UAV inspection system) with the positional information received from each control tower and navigation beacon such that the UAV is aware of the positions of the control tower(s) and navigation beacons at the site of operation (e.g., prior to takeoff).

The pre-flight environmental flight conditions inspection determines that conditions (e.g., weather, wind, and air traffic) at the site of operation are conducive for safe and successful execution of the flight plan, before the flight plan is actually executed. In some embodiments, the flight manager enables all or a subset of the systems and sensors on the control tower(s), the navigation beacons, the UAV inspection system(s), and/or the UAV(s). In response, these devices (a) capture data with the enabled systems and sensors and (b) transmit (e.g., stream) the data to the control tower and/or the flight manager. In one specific example, the control tower and the navigation beacons capture (i) weather data using the weather sensors and (ii) air traffic data using their cameras by capturing video or images of the airspace within and/or surrounding the site of operation and/or the operational envelope. Additionally, or alternatively, the control tower captures air traffic data using its ADS-B system and/or its radar system. The navigation beacons transmit (e.g., stream) the weather and video/image data to a control tower, which can be a specific control tower of the system that is specified in instructions received from the flight manager.

In turn, the control tower transmits weather and/or air traffic data to the flight manager. Air traffic data transmitted to the flight manager can include (a) the video/image data captured by the control tower and/or the navigation beacons, and/or (b) positional information for air traffic obstructions (e.g., foreign objects, other aircraft, birds, and/or other objects posing a risk to the UAV within the airspace at or around the site of operation) identified within the video/image data. For example, the control tower can process the video/image data captured by the control tower and/or the navigation beacons to determine the positional information for the air traffic obstructions. Processing the captured video/image data can include (a) identifying an air traffic obstruction in the video/image data captured by a system component (e.g., by a control tower or by a navigation beacon), and (b) determining a first bearing of the air traffic obstruction with respect to the system component based at least in part on the orientation of the system component determined using a compass of the system component. The processing can further include combining the first bearing with at least one other bearing of the air traffic obstruction determined from video/image data captured using another control tower or navigation beacon. In particular, the processing further includes using the two or more bearings with the known positions of the corresponding control towers and/or navigation beacons to triangulate the air traffic obstruction's position in two-dimensional and/or three-dimensional space. The control tower can send positional information for identified air traffic obstructions to the flight manager before, while, after, or in lieu of sending the captured video/image data to the flight manager. Additionally, or alternatively, the control tower can send the captured video/image data to the flight manager, and the flight manager can perform processing of the video/image data to determine positional information for air traffic obstructions.

The flight manager continuously monitors the data it receives from the control tower to verify site safety prior to flight plan execution. For example, the flight manager can compare wind and other weather data to corresponding safe operating thresholds or ranges. If the wind or other weather data violates (e.g., exceeds the thresholds or is outside of the safe operating ranges), the UAV can be prevented from executing the flight plan (at least until the weather data indicates that weather at the site is conducive to safely executing the flight plan). As another example, the flight manager monitors the positional information for air traffic obstructions, estimate their general trajectories, and determines whether any of the air traffic obstructions poses a risk (e.g., a risk of collision) with the UAV. If an air traffic obstruction poses a risk (e.g., above a probability threshold) of colliding or otherwise interfering with the UAV, the UAV can be prevented from executing the flight plan (at least until the air traffic obstruction no longer poses a risk of colliding or otherwise interfering with the UAV).

At block 904, the method 900 continues by performing a pre-flight airspace authorization check. In some embodiments, the flight manager performs the pre-flight airspace authorization check by communicating with (or otherwise retrieving reports or information issued by) flight agencies local to the site of operation regarding current flight restrictions or notices to airmen (NOTAMs). If the flight manager determines that there are current flight restrictions and/or NOTAMs related to the UAV's operational envelope and/or to (all or a portion of) the flight path and/or emergency flight paths defined by the flight plan, the flight manager can determine if the flight plan violates the current flight restrictions and/or NOTAMs. If the flight manager determines that the flight plan violates the current flight restrictions and/or NOTAMs, the flight manager can (i) alter the flight plan (e.g., the flight path and/or emergency flight paths defined by the flight plan) to adhere to the current flight restrictions and/or NOTAMs, (ii) trigger a notification to a user (e.g., an operator) of the system, and/or (iii) prevent the UAV from executing the flight plan (at least until the flight plan is no longer in violation of current flight restrictions and/or NOTAMs).

The method 900 continues at block 905 to execute the flight plan. In some embodiments, the UAV is permitted to execute the flight plan only if the UAV passes the pre-flight inspection, if all components (e.g., the control tower, the navigation beacons, the UAV inspection system) are connected to the flight manager, if environmental (e.g., weather and/or air traffic) conditions are conducive to the UAV safely and successfully executing the flight plan, and/or when the flight plan is in compliance with current flight restrictions and/or NOTAMs. Execution of the flight plan is discussed in greater detail below with respect to FIGS. 9A and 9B.

FIG. 9A is a flow diagram illustrating a method 910 of executing a flight plan in accordance with various embodiments of the present technology. All or a subset of the steps of the method 910 can be executed by various components or devices of an autonomous UAV operational containment system (“the system”), such as the system 100 illustrated in FIGS. 1A and 1B or other suitable systems. For example, all or a subset of the steps of the method 910 can be executed by components or devices of a UAV, such as the multi-processor UAV 120 (FIGS. 1A, 1B, and 3). Furthermore, any one or more of the steps of the method 910 can be executed in accordance with the discussion above.

The method 910 begins at block 911 by the UAV departing from the docking station of the UAV inspection system in response to a command received from (e.g., the scheduler module of) the flight manager. As discussed above with respect to blocks 903-905 of the method 900 illustrated in FIG. 9, the UAV, in some embodiments, is permitted to depart from the docking station and begin executing a flight plan only when the UAV passes a pre-flight inspection, when all components (e.g., the control tower, the navigation beacons, the UAV inspection system) of the system are connected to the flight manager, when environmental (e.g., weather and/or air traffic) conditions are conducive to the UAV safely and successfully executing the flight plan within the operational envelope of the UAV, and/or when the flight plan is in compliance with current flight restrictions and/or NOTAMs.

Under normal, safe, and/or successful execution of a flight plan, the UAV autonomously performs blocks 912 and 913 (including subblocks 912a-912f of the block 912) without ever proceeding to blocks 914 and/or 915. That is, the UAV departs the docking station at block 911, executes a flight plan at block 912 by following a flight path and performing specified actions defined in the flight plan, and returns to the docking station at block 913. Stated another way, the UAV typically (a) proceeds to block 914 only in the event that the UAV identifies an in-flight emergency and/or (b) proceeds to block 915 only in the event that (i) the flight manager identifies an in-flight emergency, (ii) a user of the system takes manual control of the UAV via the flight manager, and/or (iii) the flight manager transmits navigation commands to the UAV. Blocks 912-915 (including subblocks 912a-912f) are discussed in greater detail below.

At block 912, the method 910 continues by following a flight path defined in the flight plan and/or by performing actions specified in the flight plan. To follow the defined flight path, the flight controller of the UAV manages the UAV's position in three-dimensional space, adjusting the UAV's current position in space to align with a next position in space defined by the flight path. As part of this process, the UAV uses redundant localization systems to determine its current position in space. For example, at subblock 912a, the UAV determines a position of the UAV using a first localization system, such as the UAV's onboard GPS system. Additionally, at subblock 912b, the UAV determines a position of the UAV using a second localization system independent of and different from the first localization system. For example, the second localization system can be the UAV's onboard RF localization system. In some embodiments, an altitude determined by the first localization system and/or the second localization system can be verified using a separate system or sensor (e.g., a pressure sensor) onboard the UAV. In these and other embodiments, the UAV reports the position determined using the first localization system and/or the position determined using the second localization system to the flight manager and/or other components of the system.

In one embodiment, the UAV's RF localization system determines the position of the UAV in space by communicating with the control tower(s) and/or the navigation beacons deployed at the site of operation. In particular, the RF localization system determines which control tower(s) and/or navigation beacons are in the UAV's vicinity and continually pings those control tower(s) and/or navigation beacons with information packets. For example, the RF localization system determines which control tower(s) and/or navigation beacons are in its vicinity by comparing a current position of the UAV (i) to positional information of the control tower(s) and navigation beacons provided to the UAV by the flight manager pre-flight (as discussed above with respect to block 903 of the method 900 of FIG. 9) and/or (ii) to updated positional information of the control tower(s) and navigation beacons provided to the UAV during flight. Starting with control tower(s) and/or navigation beacons of the system having positions closest to the UAV's current position, the RF localization system can attempt to communicate with these control tower(s) and/or navigation beacons by pinging them with information packets. If attempts to communicate with a control tower or a navigation beacon are unsuccessful, the RF localization system can attempt to communicate with a next closest control tower and/or navigation beacon to the UAV's current position and continue with this process at least until the RF localization is successfully able to communicate with three components of the system comprising control tower(s) and/or navigation beacons. Failure to successfully communicate with at least three components of the system can indicate (i) a control tower and/or a navigation beacon has lost connectivity with the system, and/or (ii) deployment of the control tower(s) and/or the navigation beacons at the site of operation is deficient (e.g., is not providing blanket LAN coverage to the site of operation or to at least the operational envelope of the UAV). As discussed in greater detail below with respect to subblock 912e, the UAV can proceed to block 914 to take emergency action when the UAV is unable to successfully communicate with at least three components of the system.

When attempts to communicate with a control tower or a navigation beacon are successful, the control tower or navigation beacon immediately returns an information packet received from the UAV back to the UAV. In turn, the UAV determines the RTT of the information packet and converts the RTT into a physical distance between the UAV and that control tower or navigation beacon using the speed of light and known dynamics of the network. The above process is repeated for other control towers and/or navigation beacons in the UAV's vicinity and with which the UAV is successfully able to communicate.

Because the RTT of information packets can vary depending on the size of the packet, the size of information packets sent between the UAV and the control tower(s) or navigation beacons are kept small and/or relatively constant. For example, an information packet may include only a packet ID, a media access control (MAC) address of a control tower's or navigation beacon's (e.g., LAN or mesh) network radio to which the information packet is addressed, and/or a message type identifier (e.g., an RTT message type identifier) to minimize processing of the packet by the control tower of the navigation beacon and reduce the time elapsed before the control tower or the navigation beacon returns the information packet to the UAV.

Using (a) multiple (e.g., three or more) physical distances determined between multiple (e.g., three of more) control towers and/or navigation beacons of the system and (b) the known locations of those control towers and/or navigation beacons, the RF localization system can calculate the position of the UAV in space using, for example, trilateration. As discussed above, the precise locations of the control towers and/or navigation beacons are known because (i) each of these components includes an onboard GPS that is used to report its positional information to the flight manager before execution of the flight plan and (ii) the flight manager provides the UAV with this positional information pre-flight (as discussed above with respect to block 903 of the method 900 of FIG. 9) and/or whenever the positional information for a control tower and/or a navigation beacon is updated during flight of the UAV.

At subblock 912c, after the UAV obtains the position of the UAV determined using the first localization system at subblock 912a and the position of the UAV determined using the second localization system at subblock 912b, the UAV proceeds to compare these determined positions to one another. Any difference between these determined positions of the UAV can be compared to one or more difference thresholds to determine whether the positions differ from one another to an extent that there is cause for concern. For example, if a difference between the determined positions exceeds a difference threshold, the method 910 can proceed to block 914 such that the UAV takes emergency action. Otherwise, the method 910 can proceed to subblock 912d.

In the event the UAV uses multiple difference thresholds for the comparison performed at subblock 912c, the emergency action taken by the UAV at block 914 can depend on which of the difference thresholds are exceeded. For example, if the difference between the determined positions of the UAV exceed a first difference threshold but not a second difference threshold, the UAV can take emergency action (a) by slowing its velocity and/or hovering in place and (b) waiting for a recalculated position of the UAV determined used the first localization system and/or a second recalculated position of the UAV determined using the second localization system, to stabilize and come back into alignment. If the recalculated positions come back into alignment within a specified period of time, the method 910 can return to block 912 and/or proceed to subblock 912d.

On the other hand, if the recalculated positions do not come back into alignment within the specified amount of time and/or if the difference between the originally determined positions exceeds both the first and second difference thresholds, the UAV can (i) execute the emergency flight plan of the flight plan and proceed to land at a safe landing zone defined in the emergency flight plan for the portion of the flight path corresponding to the UAV's current (or last known) position, and/or (ii) deploy an emergency parachute of the UAV, allowing the UAV to safely drop to the ground. Failure of the recalculated positions to stabilize or come back into alignment can indicate a hardware malfunction or a potential compromise (e.g., hack) of one of the UAV's localization systems. In some embodiments, a notification is sent to a service technician to investigate the cause of the difference between the determined and/or recalculated positions. In these and other embodiments, the UAV can return to block 912 and/or proceed to subblock 912d if the recalculated positions of the UAV come into alignment (e.g., within a specified period of time) when the UAV is executing the emergency flight plan and/or after the UAV has successfully landed at the corresponding safe landing zone. In this manner, the redundant localization systems onboard the UAV increases the likelihood of safe operation of the UAV, even in the event that one of the localization systems fails, malfunctions, or is otherwise compromised (e.g., is hacked).

At subblock 912d, the method 910 continues by determining whether the current position of the UAV (a) is approaching a violation of or is already violating the UAV's operational envelope or (b) is deviating from the flight path defined in the flight plan. As discussed above with respect to FIG. 3, the positions of the UAV determined using the first and second localization systems of the UAV are sent to both the flight controller and the oversight processor of the UAV. As such, the oversight processor can check (a) the current position of the UAV (as defined by the positions of the UAV determined using the first and second localization system of the UAV) and/or (b) the UAV's current trajectory, velocity, and/or acceleration to determine if the UAV is about to violate or is currently violating its operational envelope. In the event the oversight processor determines that the UAV is not currently in violation of the UAV's operational envelope but is approaching a violation, the oversight processor can notify the flight controller of an impending violation, and the flight controller can take corrective action. If (i) the flight controller fails to take corrective action, (ii) violation of the operational envelope is likely or inevitable, and/or (iii) the current position of the UAV violates the UAV's operational envelope, the method 910 can proceed to block 914 such that the UAV takes emergency action. A similar procedure can be performed if the flight controller and/or the oversight processor determine that the UAV is deviating from the flight path defined in the flight plan by more than one or more deviation thresholds.

If the method 910 proceeds to block 914 from subblock 912d, the UAV can be configured to take one or more emergency actions. In some embodiments, the oversight processor of the UAV communicates with the flight controller over a uni-directional communications line to trigger an alert or alarm, to reduce operational velocity of the UAV, force execution of alternate instructions (e.g., to hover in place, to immediately return the UAV to within the operational envelope and/or to the flight path, to land the UAV within a safe landing zone designated in the emergency flight plan, to return the UAV to the docking station, and/or to perform another action to attempt to bring the UAV back into a safe operating state), to execute a gradual shutdown procedure, and/or to temporarily or permanently disable the UAV. Additionally, or alternatively, the oversight processor can employ a flight termination system. For example, the oversight processor can assert a reset signal over a uni-directional reset communications line to permanently or temporarily cease functionality of the flight controller and/or to the oversight processor can deploy an emergency parachute of the UAV (allowing the UAV to safely drop to the ground). In this manner, the UAV continually checks its position against its operational envelope and/or the defined flight path, and the multi-processor architecture of the UAV increases the likelihood of safe operation of the UAV, even in the event that the flight controller fails, malfunctions, or is otherwise compromised (e.g., is hacked).

On the other hand, if the oversight processor detects no current or impending violation of the UAV's operational envelope, and/or if the flight controller and/or the oversight processor detect no significant deviation (e.g., deviation above one or more deviation thresholds) from the flight plan, the method 910 can proceed to subblock 912e.

At subblock 912e, the method 910 continues by determining whether any internal emergencies of the UAV have been detected. Examples of internal emergencies of the UAV include loss of connectivity to various components (e.g., to the control tower(s), the navigation beacons, and/or the flight manager) of the system; failure to successfully send/receive information packets to at least three components (e.g., comprising control tower(s) and/or navigation beacons) of the system when using an RF localization system; and/or failure, malfunction, or other compromise (e.g., hack) of a UAV sensor or system. In some embodiments, the UAV can use various systems and/or sensors (e.g., an onboard accelerometer) to determine whether the UAV is exhibiting abnormal flight behavior indicative of failure, malfunction, or other compromise (e.g., hack) of a UAV sensor or system. In the event that an internal emergency is detected at subblock 912e, the method 910 proceeds to block 914 such that the UAV takes emergency action. Otherwise, the method 910 proceeds to subblock 912f.

In the event the method 910 proceeds to block 914 from subblock 912e, the UAV can be configured to take one or more emergency actions dependent, for example, of the type and/or severity of the internal emergency detected. For example, in the event that the UAV loses connectivity with components of the system and/or is unable to send/receive information packets to at least three components (comprising control tower(s) and/or navigation beacons) of the system when using an RF localization system, the UAV can hover in place and wait for connectivity and/or communication with at least three components to be restored. Additionally, or alternatively, the UAV can (e.g., immediately or after hovering in place for a specified period of time) execute the portion of the emergency flight plan corresponding to the UAV's current position along the flight path, land at the designated safe landing zone, and wait for connectivity/communication to be restored. In some embodiments, if connectivity and/or communication is restored, the method 910 can return to block 912 and/or proceed to subblock 912f. If connectivity and/or communication is permanently lost, the UAV can stay grounded at the safe landing zone until a field technician is deployed to investigate, debug, and restore connectivity and/or communication.

As another example, in the event that the UAV identifies that an onboard system and/or sensor has failed, is malfunctioning, and/or is otherwise compromised (e.g., is hacked), the UAV can determine whether the UAV is stable and can be safely maneuvered to the ground (e.g., to a safe landing zone). If the UAV is stable, the UAV can (i) execute the portion of the emergency flight plan corresponding to the UAV's current position along the flight path, (ii) land at the designated safe landing zone, and (iii) wait for a service technician to investigate. On the other hand, if the UAV determines that the UAV is unstable (e.g., that a propeller has failed), the UAV can kill its motors and deploy an emergency parachute to allow the UAV to safely drop to the ground. A notification can be sent to a service technician to investigate.

At subblock 912f, the method 910 continues by determining whether the UAV has received a command from the flight manager. For example, when a position of a control tower and/or a navigation beacon of the system has changed while the UAV is in flight, the flight manager can instruct the UAV to hover in place (e.g., at least until the UAV receives the updated positions of the control tower(s) and/or the navigation beacons from the flight manager). Thus, when the UAV receives instructions from the UAV to hover in place, the method 1240 proceeds to block 1245 and the UAV executes the hover and update position commands.

As another example, a user can opt to take manual control of the UAV via the webserver portal of the flight manager. In this event, the flight manager transmits commands to the UAV corresponding to the manual commands received from the user. Thus, when the UAV receives the manual control commands, the method 910 proceeds to block 915 and the UAV executes the manual control commands.

As yet another example, the navigation beacons, control tower, and flight manager can continuously capture data related to (and/or can continuously monitor environmental conditions of) the site of operation while the UAV executes the flight plan. As discussed in greater detail below with respect to FIG. 9B, the flight manager can identify external emergencies that can jeopardize the safe and/or successful execution of the flight plan based at least in part on the captured data and/or environmental conditions. As such, the flight manager can generate commands for the UAV to execute in response to identifying an external emergency and can transmit these commands to the UAV. When the UAV receives these commands, the method 910 can proceed from subblock 912f to block 915 to execute the commands. Examples of commands that the flight manager can transmit to the UAV and that the UAV can execute include taking evasive action (e.g., by deviating from the flight path), hovering in place (e.g., for a specified period of time), returning to the docking station, and/or executing a portion of the emergency flight plan corresponding to the UAV's current position to land at a safe landing zone. In some embodiments, the method 910 can return to block 912 after there is no longer an external emergency (e.g., after there is no longer a risk of collision or other interference between the UAV and another object, after safe weather conditions have returned, and/or after another scenario posing a risk to the UAV has passed).

If no commands are received from the flight manager at subblock 912f, the method 910 can return to subblock 912a, and the subblocks 912a-912f can be repeated until the UAV completes traversing the defined flight path and/or performing the actions specified in the flight plan. At that point, the method 910 can proceed to block 913 to land the UAV at the docking station.

FIG. 9B is a flow diagram illustrating another method 920 of executing a flight plan in accordance with various embodiments of the present technology. All or a subset of the steps of the method 920 can be executed by various components or devices of an autonomous UAV operational containment system (“the system”), such as the system 100 illustrated in FIGS. 1A and 1B or other suitable systems. For example, all or a subset of the steps of the method 920 can be executed by (i) components or devices of the flight manager 110 (FIGS. 1A, 1B, and 2), (ii) components or devices of the control tower(s) 130 (FIGS. 1A, 1B, and 4), and/or (iii) components or devices of the navigation beacon(s) 140 (FIGS. 1A, 1B, and 5). Furthermore, any one or more of the steps of the method 920 can be executed in accordance with the discussion above.

The method 920 begins at block 931 by launching the UAV such that the UAV departs from the docking station of the UAV inspection system (or from another location) and begins executing a flight plan. To launch the UAV, the flight manager (e.g., the scheduler module) can send a launch command to the UAV (e.g., at a date and time specified in the flight plan). As discussed above with reference to blocks 90-905 of the method 900 illustrated in FIG. 9, the flight manager, in some embodiments, transmits the launch command to the UAV only when the UAV passes a pre-flight inspection, when all components (e.g., the control tower, the navigation beacons, the UAV inspection system) of the system are connected to the flight manager, when environmental (e.g., weather and/or air traffic) conditions are conducive to the UAV safely and successfully executing the flight plan within the operational envelope of the UAV, and/or when the flight plan is in compliance with current flight restrictions and/or NOTAMs.

Under normal, safe, and/or successful execution of a flight plan, the components (e.g., the flight manager, control tower(s), and/or navigation beacon(s)) execute blocks 922-926 of the method 920 without ever proceeding to blocks 927 and 928. That is, after launching the UAV at block 921, the flight manager continuously monitors site conditions for the entire duration the UAV executes the flight plan and/or until the UAV returns to the docking station. Stated another way, the method 920 typically (a) proceeds to blocks 927 and 928 only in the event that the flight manager, the control tower(s), and/or a navigation beacon identify an in-flight emergency and/or (b) proceeds directly to block 928 only in the event that a user requests manual control of the UAV via the flight manager. Blocks 922-928 are discussed in greater detail below.

At block 922, the method 900 continues by receiving positional information of the UAV. As discussed above, the flight manager can receive the UAV's current GPS position and/or current RF localized position in space from the UAV. Additionally, or alternatively, the UAV's position can be determined using other systems or sensors of the system. For example, the UAV's position can be determined from video/image data captured by the control tower(s) and/or the navigation beacons, and/or the UAV's position can be determined using the radar and/or ADS-B systems of the control tower(s).

At block 923, the method 900 continues by receiving and processing system sensor data. In some embodiments, the flight manager enables various systems and sensors onboard the control tower(s) and/or the navigation beacons of the system while the UAV is in-flight and/or executing a flight plan. These various systems and sensors can include GPS systems and/or compasses on the control tower(s) and/or navigation beacons; cameras on the control tower(s) and/or navigation beacons; weather sensors on the control tower(s) and/or navigation beacons; radar systems on the control tower(s); and/or ADS-B systems on the control tower(s). Thus, the various systems and sensors can generate positional information data and/or orientation data determined by the GPS systems and/or by the compasses, respectively; video/image data captured by the cameras; weather data (e.g., temperature, wind, pressure, and/or other weather-related data) captured by the weather sensors; and/or air traffic data captured by the radar and/or ADS-B systems. All or a portion of this data can be transmitted from the navigation beacons to the control tower(s), and/or from the control tower(s) to the flight manager, as discussed in greater detail above.

In some embodiments, the control tower(s) can process at least some of the captured data. For example, as discussed in greater detail above with respect to block 903 of the method 900 illustrated in FIG. 9, the control tower(s) can process the video/image data and/or the orientation data to (a) identify air traffic obstructions and (b) determine positional information for the identified obstructions. For example, the control tower can process the video/image data and/or the orientation data to generate a (e.g., three-dimensional) map of airspace at the site of operation with all objects therein. The positional information (e.g., the map of the airspace) can be sent to the flight manager in addition to or in lieu of the video/image data. Additionally, or alternatively, the video/image data can be sent to the flight manager for processing by the flight manager.

In these and other embodiments, the flight manager processes the system sensor data it receives from the control tower(s). For example, as discussed in greater detail below with respect to block 924, the flight manager can process the radar, ADS-B, video/image, and/or positional information data to (a) identify air traffic obstructions and/or (b) determine whether the air traffic obstructions pose a risk of colliding or otherwise interfering with the UAV. Additionally, or alternatively, the flight manager can process weather data to determine if weather conditions at the site of operation pose a risk to the UAV, as discussed in greater detail below with respect to block 925. In these and other embodiments, the flight manager can process positional information of the control tower(s) and/or the navigation beacons to determine if the position of a control tower or a navigation beacon has changed. If the flight manager determines that the position of a control tower or a navigation beacon has changed, the flight manager can (i) provide the UAV with the updated position(s) of the control tower(s) and/or the navigation beacons and/or (ii) instruct the UAV to hover in place (e.g., at least until the UAV receives the updated positions).

At block 924, the method 920 continues by determining whether (a) an air traffic obstruction has been detected and (b) whether the detected obstruction poses a risk of colliding or otherwise interfering with the UAV. In some embodiments, the flight manager determines if there is a risk of collision or interference by comparing the position, trajectory, and/or velocity of the detected obstruction to the position, trajectory, and/or velocity of the UAV. If the detected obstruction and the UAV are set to collide and/or pass within a threshold distance such that interference is likely, the method 920 can proceed to block 927. Otherwise, the method 920 can proceed to block 925.

At block 927, the flight manager determines an appropriate response to the risk of collision or interference. For example, the flight manager can determine that collision and/or interference can be avoided if the UAV takes evasive action (e.g., changes altitude or otherwise deviates from the flight path), hovers in place (e.g., for a specified period of time), returns to the docking station, and/or executes a portion of the emergency flight plan corresponding to the UAV's current position along the flight path to land at a designated safe landing zone. Once the flight manager has determined an appropriate response to the risk of collision or interference, the method 920 can proceed to block 928 where the flight manager transmits one or more commands to the UAV for the UAV to execute the appropriate response. In some embodiments, the method 920 can return to any one of the blocks 922-926 after there is no longer a risk of collision or interference.

At block 925, the method 920 continues by determining if weather conditions at the site of operation pose a risk to safe operation of the UAV. For example, the flight manager can compare temperature, wind, pressure, and/or other weather data to one or more weather thresholds. If the weather data violates the weather threshold(s), the method 920 can proceed to block 927. Otherwise, the method 920 can proceed to block 926.

Referring again to block 927, the flight manager determines an appropriate response to weather conditions violating the one or more weather thresholds. In some embodiments, the appropriate response can depend at least in part on which of the weather thresholds have been violated. For example, if wind data exceeds a first wind threshold but not a second, greater wind threshold, the flight manager can determine that the appropriate response is for the UAV (a) to change altitude, (b) hover in place, and/or (c) return to the docking station. If the wind data instead exceeds both the first and second wind thresholds, the flight manager may determine that the appropriate response is to immediately ground the UAV by executing a portion of the emergency flight plan corresponding to the UAV's current position along the flight path to land at a designated safe landing zone. Once the flight manager has determined an appropriate response to the weather conditions, the method 920 can proceed to block 928 where the flight manager transmits one or more commands to the UAV for the UAV to execute the appropriate response. In some embodiments, the method 920 can return to any one of the blocks 922-926 after weather conditions have improved to safe operating conditions.

At block 926, the method 920 continues by determining if the flight manager has received a request for manual control of the UAV. For example, a user can request manual control of the UAV at any time via the webserver portal of the flight manager. If the flight manager detects that the user is requesting manual control, the method 920 can proceed to block 928 where the flight manager issues one or more commands to the UAV in line with the manual control instructions received from the user via the webserver portal.

On the other hand, if no request for manual control is received at block 926, the method 920 can return to 923 to re-execute any one of more of blocks 922-928. In some embodiments, this can continue until the UAV is no longer in-flight (e.g., until the UAV has returned to the docking station, has landed in a safe landing zone, and/or has otherwise been grounded).

Although the steps of the methods 900, 910, and 920 are discussed and illustrated in a particular order, the methods 900, 910, and 920 illustrated in FIGS. 9, 9A, and 9B, respectively, are not so limited. In other embodiments, any of the methods 900, 910, and 920 can be performed in a different order. In these and other embodiments, any of the steps of the methods 900, 910, and/or 920 can be performed before, during, and/or after any of the other steps of the methods 900, 910, and/or 920. Moreover, a person of ordinary skill in the relevant art will recognize that the illustrated methods 900, 910, and/or 920 can be altered and still remain within these and other embodiments of the present technology. For example, one or more steps of the methods 900, 910, and/or 920 illustrated in FIGS. 9, 9A, and 9B, respectively, can be omitted and/or repeated in some embodiments.

Embodiments of the present technology therefore provide UAV systems, including UAV operational containment systems (and associated systems, devices, and methods), that facilitate safe, autonomous operation of a UAV in BVLOS scenarios. For example, the systems facilitate defining operational envelopes for UAVs tailored to any site of operation. Redundant localization systems and/or multiple (e.g., two or more) processors on the UAVs increase the likelihood that the UAVs are bound to and remain within the defined operational envelopes. One or more control tower(s) and/or a plurality of navigation beacons at each site provide continuous connectivity between the UAV and a cloud-based flight manager at all positions of the UAV within the operational envelope. The cloud-based flight manager reduces the overhead cost of providing an onsite flight manager, facilitates control over the system from anywhere there is an Internet connection, and provides scalable processing power to respond to the needs of any site of operation.

Furthermore, the systems continuously collect and monitor data to identify emergencies both internal and external the UAVs. In addition, the systems (a) facilitate a user specifying safe landing zones at a site of operation, and/or (b) define (e.g., pre-flight) an emergency flight plan to one of the safe landing zones for every point or segment along a flight path of a UAV. As a result, in the event the systems identify an emergency during flight of a UAV, the UAV can quickly and safely respond to the emergency (e.g., by executing one or more actions specified in commands received from the flight manager, by executing an emergency flight plan corresponding to the UAV's current position along its flight path to land at one of the safe landing zones at the site of operation, and/or by deploying an emergency parachute and floating to the ground).

### C. Additional Examples

Several aspects of the present technology are set forth in the following examples. Although several aspects of the present technology are set forth below in examples directed to systems and methods, these aspects of the present technology can similarly be set forth in examples directed to methods and systems, respectively, in other embodiments. Additionally, or alternatively, these aspects of the present technology may be set forth in examples directed to non-transitory, computer-readable media in other embodiments.

1. An unmanned aerial vehicle (UAV) operational containment system, comprising:
a cloud-based flight manager;
a control tower deployable at a site of operation and configured for direct communication with the flight manager; and
a plurality of navigation beacons deployable at the site of operation, wherein each navigation beacon of the plurality of navigation beacons is configured for communication with the control tower and for communication with the cloud-based flight manager via the control tower.

2. The UAV operational containment system of example 1, further comprising a UAV having a plurality of localization systems, wherein:
each localization system in the plurality of localization systems is configured to determine a position of the UAV independent of other localization systems of the plurality of localization systems; and
the UAV is configured for communication with (a) the control tower and each navigation beacon of the plurality of navigation beacons and (b) the cloud-based flight manager via the control tower.

3. The UAV operational containment system of example 2, wherein the plurality of localization systems includes a global positioning system (GPS) and a radiofrequency (RF) localization system.

4. The UAV operational containment system of example 3, wherein the RF localization system is configured to determine the position of the UAV using round trip times (RTTs) of information packets sent between (a) the UAV and (b) navigation beacons of the plurality of navigation beacons and/or the control tower.

5. The UAV operational containment system of any of examples 2-4, wherein the UAV is configured to (a) constrain autonomous flight of the UAV to within an operational envelope for the site of operation and (b) execute an emergency flight plan to land at a safe landing zone in an event of an in-flight emergency, wherein:
the operational envelope and emergency flight plan are defined in or by the cloud-based flight manager; and
the safe landing zone is specified in the emergency flight plan and corresponds to a position of the UAV at a time of the in-flight emergency.

6. The UAV operational containment system of any of examples 1-5, wherein the control tower and each navigation beacon of the plurality of navigation beacons are configured for communication with one another to establish a mesh network at the site of operation.

7. The UAV operational containment system of any of examples 1-6, wherein the control tower comprises:
a microcontroller;
a first network communications interface operably coupled to the microcontroller and configured for direct communication with the cloud-based flight manager;
a second network communications interface operably coupled to the microcontroller and configured for communication with navigation beacons of the plurality of navigation beacons;
a global positioning system (GPS) operably coupled to the microcontroller; and
a plurality of systems and/or sensors operably coupled to the microcontroller, wherein the plurality of systems and/or sensors include a radar system, an ADS-B system, a weather sensor, a camera, and/or a compass.

8. The UAV operational containment system of any of examples 1-7, wherein a navigation beacon of the plurality of navigation beacons comprises:
a microcontroller;
a network communications interface operably coupled to the microcontroller and configured for communication with the control tower;
a global positioning system (GPS) operably coupled to the microcontroller; and
at least one system and/or sensor operably coupled to the microcontroller, wherein the at least one system and/or sensor include a weather sensor, a camera, and/or a compass.

9. The UAV operational containment system of any of examples 1-8, wherein:
the cloud-based flight manager includes (i) a plurality of agents or modules and (ii) a webserver portal, wherein the plurality of agents or modules include a management agent and a telemetry agent;
the management agent is configured to process weather and air traffic data captured at the site of operation to identify a risk to a UAV;
the telemetry agent is configured to communicate with and/or control the UAV based at least in part on the risk identified by the management agent;
the webserver portal is configured to receive inputs from a user via a user interface, wherein the inputs define an operational envelope for the site of operation, identify safe landing zones within the site of operation, and/or are instructions to manually control flight of the UAV; and
the operational envelope defines airspace at the site of operation to which autonomous flight of the UAV is constrained.

10. The UAV operational containment system of any of examples 1-9, further comprising a UAV inspection system having a docking station for a UAV and/or a visual scanning system configured to capture data related to health of the UAV.

11. A method of operating an unmanned aerial vehicle (UAV) operational containment system, the method comprising:
defining, using a flight manager of the UAV operational containment system, an operational envelope for a site of operation, wherein the operational envelope defines airspace at the site of operation to which autonomous flight of a UAV of the UAV operational containment system is constrained;
identifying, using the flight manager, one or more safe landing zones on a floor of the operational envelope corresponding to one or more landing surfaces at the site of operation upon which the UAV can attempt to land in an event of an in-flight emergency; and
providing parameters of the operational envelope and the one or more safe landing zones to the UAV.

12. The method of example 11, wherein defining the operational envelope includes identifying locations of property boundaries of the site of operation, locations of a perimeter for the operational envelope, locations of no-fly zones within the site of operation, and/or locations and altitude limits of altitude restricted areas within the site of operation.

13. The method of example 11 or example 12, wherein defining the operational envelope includes:
receiving, via a user interface of the flight manager, input from a user indicating a perimeter of the operational envelope, a no-fly zone within the site of operation, and/or an altitude restricted area within the site of operation; and
projecting, onto a map of the site of operation presented in the user interface, a representation of the perimeter, the no-fly zone, and/or the altitude restricted area, respectively.

14. The method of any of examples 11-13, wherein identifying the safe landing zone includes:
receiving, via a user interface of the flight manager, input from a user indicating the one or more safe landing zones at the site of operation; and
projecting a representation of the one or more safe landing zones onto a map of the site of operation presented in the user interface.

15. The method of any of examples 11-14, wherein providing parameters of the operational envelope and the one or more safe landing zones to the UAV includes providing the parameters to the UAV before flight of the UAV at the site of operation.

16. The method of any of examples 11-15, further comprising:
defining, using the flight manager, a flight plan for the UAV, wherein the flight plan includes a flight path for the UAV to follow when autonomously executing the flight plan;
and providing the flight plan to the UAV.

17. The method of example 16, wherein defining the flight plan includes:
receiving, via a user interface of the flight manager, input from a user indicating the flight path for the UAV; and
projecting a representation of the flight path onto a map of the site of operation presented in the user interface.

18. The method of example 16 or example 17, wherein defining the flight plan includes comparing the flight path to the operational envelope and rejecting all or a portion of the flight path when all or the portion of the flight path violates the operational envelope.

19. The method of any of examples 16-18, wherein:
the flight plan further includes an emergency flight plan; and
the emergency flight plan designates, for each point or segment of the flight path, a safe landing zone of the one or more safe landing zones in which the UAV can autonomously attempt to land when the UAV experiences an emergency during flight at that respective point or segment of the flight path.

20. The method of example 19, wherein defining the flight plan includes:
automatically generating a first safe landing zone designation of the emergency flight path for a first point or segment of the flight path; and/or
receiving, via a user interface of the flight manager, input from a user indicating a second safe landing zone designation of the emergency flight path for a second point or segment of the flight path.

21. A method of operating an unmanned aerial vehicle (UAV) operational containment system, the method comprising:
executing a flight plan for a UAV of the UAV operational containment system, wherein:
the flight plan includes a flight path within an operational envelope for the UAV and an emergency flight plan;
the operational envelope defines airspace at a site of operation to which autonomous flight of the UAV is constrained;
the emergency flight plan designates, for each point or segment of the flight path, a safe landing zone at the site of operation in which the UAV can autonomously attempt to land when the UAV experiences an emergency during flight at that respective point or segment of the flight path; and
executing the flight plan includes autonomously navigating the UAV along the flight path at the site of operation.

22. The method of example 21, wherein executing the flight plan further includes:
determining a position of the UAV using a first localization system of the UAV, wherein the position of the UAV determined using the first localization system is a first position of the UAV; and
determining a position of the UAV using a second localization system of the UAV, wherein the second localization system is different from and independent of the first localization system, and wherein the position of the UAV determined using the second localization system is a second position of the UAV.

23. The method of example 22, wherein:
the first localization system is a radiofrequency (RF) localization system; and
determining the first position of the UAV includes (i) capturing a round trip time (RTT) of an information packet sent between the UAV and a control tower and/or a navigation beacon of the UAV operational containment system, and (ii) determining the first position of the UAV using the RTT of the information packet.

24. The method of example 22 or example 23, wherein executing the flight plan further includes:
determining a difference between the first position and the second position;
comparing the difference to one or more thresholds; and
based at least in part of the different executing the one or more thresholds, executing the emergency flight plan for a point or segment of the flight path corresponding to a current position of the UAV, or deploying a parachute of the UAV.

25. The method of any of examples 21-24, wherein executing the flight plan further includes:
identifying, using the UAV, an internal emergency of the UAV, wherein:
   the internal emergency includes (i) loss of connectivity to a flight manager of the UAV operational containment system, to a control tower of the UAV operational containment system, and/or to a navigation beacon of the UAV operational containment system, (ii) an inability to communicate with at least three components of the UAV operational containment system, and/or (iii) failure, malfunction, or compromise of an onboard system or sensor, and
   the at least three components of the UAV operational containment system include one or more control towers and/or one or more navigation beacons; and
based at least in part on the internal emergency, executing the emergency flight plan for a point or segment of the flight path corresponding to a current position of the UAV, or deploying a parachute of the UAV.

26. The method of any of examples 21-25, further comprising:
capturing, while the UAV is in flight and using a control tower and/or a navigation beacon of the UAV operational containment system, data indicative of a weather condition at the site of operation;
identifying, based at least in part on the data and using a flight manager of the UAV operational containment system while the UAV is in flight, that the weather condition poses a risk to the UAV; and
based at least in part on the risk, executing the emergency flight plan for a point or segment of the flight path corresponding to a current position of the UAV, or instructing the UAV to return to a docking station of the UAV operational containment system.

27. The method of any of examples 21-26, further comprising:
capturing, while the UAV is in flight and using a control tower and/or a navigation beacon of the UAV operational containment system, data indicative of object in flight at the site of operation;
based at least in part on the data, identifying, while the UAV is in flight and using the control tower and/or a flight manager of the UAV operational containment system, that the object poses a risk of collision or interference to the UAV; and
based at least in part on the risk, performing an evasive action,
wherein performing the evasive action includes deviating from the flight path, hovering in place, or executing the emergency flight plan for a point or segment of the flight path corresponding to a current position of the UAV.

28. The method of any of examples 21-27, further comprising determining a position for each control tower and navigation beacon of the UAV operational containment system prior to executing the flight plan.

29. The method of any of examples 21-28, wherein the method further comprises performing an inspection prior to executing the flight plan, wherein performing the inspection includes:
determining, using a flight manager of the UAV operational containment system, that each control tower and navigation beacon of the UAV operational containment system is communicatively coupled to the flight manager;
capturing, using a control tower and/or a navigation beacon of the UAV operational containment system, data indicative of a weather condition at the site of operation and/or of an object in flight at the site of operation;
identifying, based at least in part on the data and using the flight manager and/or the control tower, that the weather condition and/or the object pose a risk to the UAV; and
based at least in part on the risk, preventing execution of the flight plan until the weather condition and/or the object no longer pose the risk.

30. The method of any of examples 21-29, wherein the method further comprises autonomously performing a visual inspection of the UAV prior to executing the flight plan, wherein autonomously performing the visual inspection includes:

capturing, using a UAV inspection system of the UAV operational containment system, one or more images of the UAV; and

comparing the one or more images of the UAV to baseline images of the UAV to identify differences in the UAV over time that are indicative of damage to the UAV.

### D. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments can perform steps in a different order. Furthermore, the various embodiments described herein can also be combined to provide further embodiments.

The systems and methods described herein can be provided in the form of tangible and non-transitory machine-readable medium or media (such as a hard disk drive, hardware memory, and/or another suitable medium) having instructions recorded thereon for execution by a processor or computer. The set of instructions can include various commands that instruct the computer or processor to perform specific operations such as the methods and processes of the various embodiments described here. The set of instructions can be in the form of a software program or application. The computer storage media can include volatile and non-volatile media, and removable and non-removable media, for storage of information such as computer-readable instructions, data structures, program modules or other data. The computer storage media can include, but are not limited to, RAM, ROM, EPROM, EEPROM, flash memory or other solid-state memory technology, CD-ROM, DVD, or other optical storage, magnetic disk storage, or any other hardware medium which can be used to store desired information and that can be accessed by components of the system. Components of the system can communicate with each other via wired or wireless communication. The components can be separate from each other, or various combinations of components can be integrated together into a monitor or processor or contained within a workstation with standard computer hardware (for example, processors, circuitry, logic circuits, memory, and the like). The system can include processing devices such as microprocessors, microcontrollers, integrated circuits, control units, storage media, and other hardware.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any materials incorporated herein by reference conflict with the present disclosure, the present disclosure controls. Where the context permits, singular or plural terms can also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and both A and B. Additionally, the terms “comprising,” “including,” “having” and “with” are used throughout to mean including at least the recited feature(s) such that any greater number of the same feature and/or additional types of other features are not precluded. Furthermore, as used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

From the foregoing, it will also be appreciated that various modifications can be made without deviating from the technology. For example, various components of the technology can be further divided into subcomponents, or various components and functions of the technology can be combined and/or integrated. Furthermore, although advantages associated with certain embodiments of the technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein.

What is claimed is:

1. An unmanned aerial vehicle (UAV) operational containment system, comprising:
a cloud-based flight manager;
a control tower deployable at a site of operation and configured for direct communication with the flight manager; and
a plurality of navigation beacons deployable at the site of operation, wherein each navigation beacon of the plurality of navigation beacons is configured for communication with the control tower and for communication with the cloud-based flight manager via the control tower.

2. The UAV operational containment system of claim 1, further comprising a UAV having a plurality of localization systems, wherein:
each localization system in the plurality of localization systems is configured to determine a position of the UAV independent of other localization systems of the plurality of localization systems; and
the UAV is configured for communication with (a) the control tower and the plurality of navigation beacons and (b) the cloud-based flight manager via the control tower.

3. The UAV operational containment system of claim 2, wherein the plurality of localization systems includes a global positioning system (GPS) and a radiofrequency (RF) localization system.

4. The UAV operational containment system of claim 3, wherein the RF localization system is configured to determine the position of the UAV using round trip times (RTTs) of information packets sent between (a) the UAV and (b) navigation beacons of the plurality of navigation beacons and/or the control tower.

5. The UAV operational containment system of claim 2, wherein the UAV is configured to (a) constrain autonomous flight of the UAV to within an operational envelope for the site of operation and (b) execute an emergency flight plan to land at a safe landing zone in an event of an in-flight emergency, wherein:
the operational envelope and emergency flight plan are defined in or by the cloud-based flight manager; and
the safe landing zone is specified in the emergency flight plan and corresponds to a position of the UAV at a time of the in-flight emergency.

6. The UAV operational containment system of claim 1, wherein the control tower and the plurality of navigation beacons are configured for communication with one another to establish a mesh network at the site of operation.

7. The UAV operational containment system of claim 1, wherein the control tower comprises:
a microcontroller;
a first network communications interface operably coupled to the microcontroller and configured for direct communication with the cloud-based flight manager;
a second network communications interface operably coupled to the microcontroller and configured for communication with navigation beacons of the plurality of navigation beacons;
a global positioning system (GPS) operably coupled to the microcontroller; and
a plurality of systems and/or sensors operably coupled to the microcontroller, wherein the plurality of systems and/or sensors include a radar system, an ADS-B system, a weather sensor, a camera, and/or a compass.

8. The UAV operational containment system of claim 1, wherein a navigation beacon of the plurality of navigation beacons comprises:
a microcontroller;
a network communications interface operably coupled to the microcontroller and configured for communication with the control tower;
a global positioning system (GPS) operably coupled to the microcontroller; and
at least one system and/or sensor operably coupled to the microcontroller, wherein the at least one system and/or sensor include a weather sensor, a camera, and/or a compass.

9. The UAV operational containment system of claim 1, wherein:
the cloud-based flight manager includes (i) a plurality of agents or modules and (ii) a webserver portal, wherein the plurality of agents or modules include a management agent and a telemetry agent;
the management agent is configured to process weather and air traffic data captured at the site of operation to identify a risk to a UAV;
the telemetry agent is configured to communicate with and/or control the UAV based at least in part on the risk identified by the management agent;
the webserver portal is configured to receive inputs from a user via a user interface, wherein the inputs define an operational envelope for the site of operation, identify safe landing zones within the site of operation, and/or are instructions to manually control flight of the UAV; and
the operational envelope defines airspace at the site of operation to which autonomous flight of the UAV is constrained.

10. The UAV operational containment system of claim 1, further comprising a UAV inspection system having a docking station for a UAV and/or a visual scanning system configured to capture data related to health of the UAV.

11. A method of operating an unmanned aerial vehicle (UAV) operational containment system, the method comprising:
defining, using a flight manager of the UAV operational containment system, an operational envelope for a site of operation, wherein the operational envelope defines airspace at the site of operation to which autonomous flight of a UAV of the UAV operational containment system is constrained;
identifying, using the flight manager, one or more safe landing zones on a floor of the operational envelope corresponding to one or more landing surfaces at the site of operation upon which the UAV can attempt to land in an event of an in-flight emergency; and
providing parameters of the operational envelope and the one or more safe landing zones to the UAV.

12. The method of claim 11, wherein defining the operational envelope includes identifying locations of property boundaries of the site of operation, locations of a perimeter for the operational envelope, locations of no-fly zones within the site of operation, and/or locations and altitude limits of altitude restricted areas within the site of operation.

13. The method of claim 11, wherein defining the operational envelope includes:
receiving, via a user interface of the flight manager, input from a user indicating a perimeter of the operational envelope, a no-fly zone within the site of operation, and/or an altitude restricted area within the site of operation; and
projecting, onto a map of the site of operation presented in the user interface, a representation of the perimeter, the no-fly zone, and/or the altitude restricted area, respectively.

14. The method of claim 11, wherein identifying the safe landing zone includes:
receiving, via a user interface of the flight manager, input from a user indicating the one or more safe landing zones at the site of operation; and
projecting a representation of the one or more safe landing zones onto a map of the site of operation presented in the user interface.

15. The method of claim 11, wherein providing parameters of the operational envelope and the one or more safe landing zones to the UAV includes providing the parameters to the UAV before flight of the UAV at the site of operation.

16. The method of claim 11, further comprising:
defining, using the flight manager, a flight plan for the UAV, wherein the flight plan includes a flight path for the UAV to follow when autonomously executing the flight plan; and
providing the flight plan to the UAV.

17. The method of claim 16, wherein defining the flight plan includes:
receiving, via a user interface of the flight manager, input from a user indicating the flight path for the UAV; and
projecting a representation of the flight path onto a map of the site of operation presented in the user interface.

18. The method of claim 16, wherein defining the flight plan includes comparing the flight path to the operational envelope and rejecting all or a portion of the flight path when all or the portion of the flight path violates the operational envelope.

19. The method of claim 16, wherein:
the flight plan further includes an emergency flight plan; and
the emergency flight plan designates, for each point or segment of the flight path, a safe landing zone of the one or more safe landing zones in which the UAV can autonomously attempt to land when the UAV experiences an emergency during flight at that respective point or segment of the flight path.

20. The method of claim 19, wherein defining the flight plan includes:
automatically generating a first safe landing zone designation of the emergency flight path for a first point or segment of the flight path; and/or
receiving, via a user interface of the flight manager, input from a user indicating a second safe landing zone designation of the emergency flight path for a second point or segment of the flight path.

21. A method of operating an unmanned aerial vehicle (UAV) operational containment system, the method comprising:
executing a flight plan for a UAV of the UAV operational containment system, wherein:
the flight plan includes a flight path within an operational envelope for the UAV and an emergency flight plan;
the operational envelope defines airspace at a site of operation to which autonomous flight of the UAV is constrained;
the emergency flight plan designates, for each point or segment of the flight path, a safe landing zone at the site of operation in which the UAV can autonomously attempt to land when the UAV experiences an emergency during flight at that respective point or segment of the flight path; and
executing the flight plan includes autonomously navigating the UAV along the flight path at the site of operation.

22. The method of claim 21, wherein executing the flight plan further includes:
determining a position of the UAV using a first localization system of the UAV, wherein the position of the UAV using the first localization system is a first position of the UAV; and
determining a position of the UAV using a second localization system of the UAV, wherein the second localization system is different from and independent of the first localization system, and wherein the position of the UAV determined using the second localization system is a second position of the UAV.

23. The method of claim 22, wherein:
the first localization system is a radiofrequency (RF) localization system; and
determining the first position of the UAV includes (i) capturing a round trip time (RTT) of an information packet sent between the UAV and a control tower and/or a navigation beacon of the UAV operational containment system, and (ii) determining the first position of the UAV using the RTT of the information packet.

24. The method of claim 22, wherein executing the flight plan further includes:
determining a difference between the first position and the second position;
comparing the difference to one or more thresholds; and
based at least in part of the different executing the one or more thresholds, executing the emergency flight plan for a point or segment of the flight path corresponding to a current position of the UAV, or deploying a parachute of the UAV.

25. The method of claim 21, wherein executing the flight plan further includes:
identifying, using the UAV, an internal emergency of the UAV, wherein:
the internal emergency includes (i) loss of connectivity to a flight manager of the UAV operational containment system, to a control tower of the UAV operational containment system, and/or to a navigation beacon of the UAV operational containment system, (ii) an inability to communicate with at least three components of the UAV operational containment system, and/or (iii) failure, malfunction, or compromise of an onboard system or sensor, and
the at least three components of the UAV operational containment system include one or more control towers and/or one or more navigation beacons; and
based at least in part on the internal emergency, executing the emergency flight plan for a point or segment of the flight path corresponding to a current position of the UAV, or deploying a parachute of the UAV.

26. The method of claim 21, further comprising:
capturing, while the UAV is in flight and using a control tower and/or a navigation beacon of the UAV operational containment system, data indicative of a weather condition at the site of operation;
identifying, based at least in part on the data and using a flight manager of the UAV operational containment system while the UAV is in flight, that the weather condition poses a risk to the UAV; and
based at least in part on the risk, executing the emergency flight plan for a point or segment of the flight path corresponding to a current position of the UAV, or instructing the UAV to return to a docking station of the UAV operational containment system.

27. The method of claim 21, further comprising:
capturing, while the UAV is in flight and using a control tower and/or a navigation beacon of the UAV operational containment system, data indicative of object in flight at the site of operation;
based at least in part on the data, identifying, while the UAV is in flight and using the control tower and/or a flight manager of the UAV operational containment system, that the object poses a risk of collision or interference to the UAV; and
based at least in part on the risk, performing an evasive action,
wherein performing the evasive action includes deviating from the flight path, hovering in place, or executing the emergency flight plan for a point or segment of the flight path corresponding to a current position of the UAV.

28. The method of claim 21, further comprising determining a position for each control tower and navigation beacon of the UAV operational containment system prior to executing the flight plan.

29. The method of claim 21, wherein the method further comprises performing an inspection prior to executing the flight plan, wherein performing the inspection includes:
determining, using a flight manager of the UAV operational containment system, that each control tower and navigation beacon of the UAV operational containment system is communicatively coupled to the flight manager;
capturing, using a control tower and/or a navigation beacon of the UAV operational containment system, data indicative of a weather condition at the site of operation and/or of an object in flight at the site of operation;
identifying, based at least in part on the data and using the flight manager and/or the control tower, that the weather condition and/or the object pose a risk to the UAV; and
based at least in part on the risk, preventing execution of the flight plan until the weather condition and/or the object no longer pose the risk.

30. The method of claim 21, wherein the method further comprises autonomously performing a visual inspection of the UAV prior to executing the flight plan, wherein autonomously performing the visual inspection includes:
capturing, using a UAV inspection system of the UAV operational containment system, one or more images of the UAV; and
comparing the one or more images of the UAV to baseline images of the UAV to identify differences in the UAV over time indicative of damage to the UAV.
